(19) United States
(12) Patent Application Publication
(10) Pub. No.: US 2021/0222025 A1
(43) Pub. Date: Jul. 22, 2021

(54) PRIMER FOR INK-JET PRINTING INKS, RECORDING MEDIUM, AND PRINTING SYSTEM

(71) Applicant: DIC Corporation, Tokyo (JP)

(72) Inventors: Hiroaki Okazaki, Kitaadachi-gun (JP); Takahiro Nio, Kitaadachi-gun (JP); Keigo Gouda, Kitaadachi-gun (JP)

(73) Assignee: DIC Corporation, Tokyo (JP)

(21) Appl. No.: 15/734,317

(22) PCT Filed: Jun. 27, 2019
(86) PCT No.: PCT/JP2019/025582

§ 371 Date: Dec. 2, 2020

(30) Foreign Application Priority Data
Jul. 10, 2018 (JP) 2018-130689

(51) Int. Cl. C09D 11/54; C08L 25/14; C08L 27/02; B41M 5/00

(52) U.S. Cl. CPC C09D 11/54; B41M 5/0017; C08L 27/02; C08L 25/14

(57) ABSTRACT

A problem to be addressed by the present invention is to provide a primer for ink-jet printing inks, the primer being capable of preventing streaks from generating on a printed material, a recording medium, and a method for producing the recording medium. The present invention relates to a primer for ink-jet printing inks, the primer containing an aqueous medium and at least one vinyl polymer (A) selected from the group consisting of a vinyl polymer (A1) having a structural unit derived from an aromatic vinyl monomer and having a glass transition temperature of 50° C. to 100° C. and a halogenated vinyl polymer (A2) having a glass transition temperature of 50° C. to 100° C.

### TECHNICAL FIELD

The present invention relates to a primer for ink-jet printing inks.

### BACKGROUND ART

In industry, a process for performing printing on packaging materials or advertising media by using ink-jet printers has been developed. An example of the packaging materials or the like is corrugated cardboard having a structure in which cardboard processed so as to have a wavy shape is sandwiched between two pieces of cardboard and bonded in this state.

Examples of the corrugated cardboard include corrugated cardboard formed of cardboard that easily absorbs a solvent contained in an ink and corrugated cardboard formed of the cardboard having, on a surface thereof, a layer that is less likely to absorb a solvent in an ink.

An example of known ink that can be used for printing on the corrugated cardboard or the like is an ink-jet printing ink composition including an aqueous emulsion resin having a glass transition temperature of 16° C. or higher and an acid value of 10 mgKOH/g or more and a pigment so as to have a solid content of 15% by weight or more and including an amino alcohol as a dispersion stabilizer (refer to, for example, Patent Literature 1).

However, when printing is performed by using an ink-jet printing ink on a recording medium such as the corrugated cardboard having a layer that is less likely to absorb a solvent contained in the ink, the ink tends to land at positions different from the correct landing positions on the surface of the recording medium. As a result, streak-like patterns to which the ink does not adhere are formed, and a printed material having a highly clear image may not be obtained.

The streak-like patterns are probably tend to generate, in particular, when the distance between the surface of the recording medium and an ink-jet head is increased.

For example, in the case where printing is performed on the surface of the corrugated cardboard by an ink-jet recording process, usually, a certain distance is often required be ensured in order to prevent contact between the surface of the corrugated cardboard and an ink-jet head due to, for example, the warpage of the sheet-like corrugated cardboard.

However, when the distance is increased, in general, the distance required for an ink ejected from an ink ejection port of the ink-jet head to land on the surface of corrugated cardboard is increased, and thus an ink droplet tends to excessively curve during the landing (flight deviation, misdirection), and wetting/spreading properties of the ink on the surface of the corrugated cardboard are insufficient, which may result in a problem such as generation of streaks on a printed material.

In particular, in the case of using, as a recording medium, a non-absorbent or poorly absorbent recording medium, such as the above-described corrugated cardboard formed of cardboard having, on a surface thereof, a color layer that is less likely to absorb a solvent in an ink, a landed ink is less likely to be absorbed by the recording medium and is less likely to wet and spread on the surface of the recording medium. Consequently, the generation of streaks may be noticeably observed in some cases.

### CITATION LIST

### Patent Literature

PTL 1: Japanese Unexamined Patent Application Publication No. 2011-12226

### SUMMARY OF INVENTION

### Technical Problem

A problem to be addressed by the present invention is to provide a primer for ink-jet printing inks, the primer being capable of preventing streaks from generating on a printed material, a recording medium, and a method for producing the recording medium.

A problem to be addressed by the present invention is to provide a printing system capable of producing a highly clear printed material having no streaks and a method for producing such a printed material.

A second problem to be addressed by the present invention is to provide an ink capable of producing a printed material having no streaks even when the distance between the surface of a recording medium and an ink-jet head is long.

### Solution to Problem

The present invention has solved the above problems by a primer for ink-jet printing inks, the primer containing an aqueous medium and at least one vinyl polymer (A) selected from the group consisting of a vinyl polymer (A1) having a structural unit derived from an aromatic vinyl monomer and having a glass transition temperature of 50° C. to 100° C. and a halogenated vinyl polymer (A2) having a glass transition temperature of 50° C. to 100° C., a recording medium having a layer (z2) formed from the primer for ink-jet printing inks, and the like.

### Advantageous Effects of Invention

The use of the primer for ink-jet printing inks according to the present invention and a particular recording medium enables streaks from being generated on a printed material.

The printing system and the method for producing a printed material according to the present invention enable the production of a printed material having no streaks even when the distance between the surface of a recording medium and an ink-jet head is long.

### DESCRIPTION OF EMBODIMENTS

A primer for ink-jet printing inks according to the present invention contains an aqueous medium and at least one vinyl polymer (A) selected from the group consisting of a vinyl polymer (A1) having a structural unit derived from an aromatic vinyl monomer and having a glass transition temperature of 50° C. to 100° C. and a halogenated vinyl polymer (A2) having a glass transition temperature of 50° C. to 100° C.

The primer for ink-jet printing inks according to the present invention is used when, for example, a layer (z2) is formed on part or the whole of a surface of a substrate (z1) such as coated paper. The layer (z2) can effectively suppress the generation of streaks when an ink is printed on the surface of the layer (z2).

The vinyl polymer (A) used is at least one selected from the group consisting of a vinyl polymer (A1) having a structural unit derived from an aromatic vinyl monomer and having a glass transition temperature of 50° C. to 100° C., and a halogenated vinyl polymer (A2) having a glass transition temperature of 50° C. to 100° C. The vinyl polymer (A1) and the vinyl polymer (A2) may be used alone or in combinations thereof.

The vinyl polymer (A1) used has a structural unit derived from an aromatic vinyl monomer and has a glass transition temperature in the range of 50° C. to 100° C. This enables the generation of streaks to be effectively suppressed.

From the viewpoint that an ink-jet printing ink easily wets and spreads on a surface of a layer (z2) described later, and consequently, the generation of streaks is effectively suppressed, the vinyl polymer (A1) used has a glass transition temperature in the range of 50° C. or higher and 100° C. or lower, preferably in the range of 75° C. or higher and 100° C. or lower, and more preferably in the range of 80° C. or higher and 100° C. or lower.

An example of the vinyl polymer (A1) that can be used is a polymer having a structural unit derived from an aromatic vinyl monomer and a structural unit derived from a (meth)acrylic monomer other than the aromatic vinyl monomer. A styrene-acrylic copolymer is preferably used.

The vinyl polymer (A1) used preferably has the structural unit derived from an aromatic vinyl monomer in an amount of 50% by mass to 99% by mass, more preferably 80% by mass to 99% by mass, relative to the total amount of the vinyl polymer (A1) from the viewpoint of more effectively suppressing the generation of streaks.

The total of the structural unit derived from a (meth)acrylic monomer other than the aromatic vinyl monomer is preferably in the range of 1% by mass to 50% by mass, more preferably in the range of 1% by mass to 20% by mass, relative to the total amount of the vinyl polymer (A1) from the viewpoint of more effectively suppressing the generation of streaks.

Examples of the aromatic vinyl monomer that can be used in the production of the vinyl polymer (A1) include vinyl monomers having one aromatic ring structure, such as styrene, α-methylstyrene, o-methylstyrene, m-methylstyrene, and p-methylstyrene. Of these, styrene is preferably used.

The aromatic vinyl monomer is preferably used in an amount in the range of 50% by mass to 99% by mass, more preferably 80% by mass to 99% by mass, relative to the total amount of monomers used in the production of the vinyl polymer (A1) from the viewpoint of more effectively suppressing the generation of streaks.

As the (meth)acrylic monomer other than the aromatic vinyl monomer, a monomer having at least one acid group, such as (meth)acrylic acid or (anhydrous) maleic acid, can be used. Examples of the (meth)acrylic monomer that can be used include (meth)acrylates such as methyl (meth)acrylate, ethyl (meth)acrylate, n-propyl (meth)acrylate, iso-propyl (meth)acrylate, n-butyl (meth)acrylate, sec-butyl (meth)acrylate, iso-butyl (meth)acrylate, tert-butyl (meth)acrylate, pentyl (meth)acrylate, neopentyl (meth)acrylate, hexyl (meth)acrylate, 2-ethylhexyl (meth)acrylate, octyl (meth)acrylate, and iso-octyl (meth)acrylate.

The (meth)acrylic monomer other than the aromatic vinyl monomer is preferably used in an amount in the range of 1% by mass to 50% by mass, more preferably in the range of 1% by mass to 20% by mass, relative to the total amount of monomers used in the production of the vinyl polymer (A1) from the viewpoint of more effectively suppressing the generation of streaks.

Among the above vinyl polymers, a vinyl polymer having a core-shell structure is preferably used as the vinyl polymer (A1) from the viewpoint of more effectively suppressing the generation of streaks.

An example of the vinyl polymer having a core-shell structure may be a vinyl polymer in which the structural unit derived from an aromatic vinyl monomer is localized in a core portion and the structural unit derived from a (meth)acrylic monomer other than the aromatic vinyl monomer is localized in a shell portion. In particular, as the vinyl polymer having a core-shell structure, it is possible to use a vinyl polymer in which the amount of structural unit derived from an aromatic vinyl monomer and present in the core portion is preferably in the range of 30% by mass to 100% by mass relative to the total amount of the structural unit derived from the aromatic vinyl monomer.

As the vinyl polymer having a core-shell structure, it is possible to use a vinyl polymer in which the amount of structural unit derived from a (meth)acrylic monomer other than the aromatic vinyl monomer and present in the shell portion is preferably in the range of 0% by mass to 70% by mass relative to the total amount of the structural unit derived from the (meth)acrylic monomer.

The vinyl polymer (A1) can be produced by polymerizing the above-described monomers by, for example, an emulsion polymerization method, a solution polymerization method, a suspension polymerization method, or a bulk polymerization method. In the vinyl polymer (A1), the vinyl polymer having a core-shell structure can be produced by, for example, polymerizing a monomer component containing a (meth)acrylic monomer other than the aromatic vinyl monomer, the monomer component being capable of constituting the shell portion, by the above method to produce a polymer (x) constituting a shell, and subsequently supplying, for example, an aromatic vinyl monomer capable of forming the core portion to a reaction vessel to cause polymerization in the particles of the polymer (x).

The vinyl polymer (A1) used, the vinyl polymer (A1) being obtained by the above method, preferably has an acid value of 150 or less, more preferably has an acid value in the range of 50 to 100, more preferably has an acid value in the range of 75 to 100, and more preferably has an acid value of 80 to 100 from the viewpoint of more effectively suppressing the generation of streaks.

From the viewpoint that an ink-jet printing ink satisfactorily wets and spreads on a surface of a layer (z2) described later, and consequently, the generation of streaks is effectively suppressed, the vinyl polymer (A1) used preferably has a minimum film-forming temperature (MFT) of 10° C. or higher and 90° C. of lower, and more preferably 20° C. or higher and 70° C. of lower.

The vinyl polymer (A1) used may be a commercially available product having a structural unit derived from styrene and a structural unit derived from a (meth)acrylic monomer, such as “JONCRYL PDX-7700”, “JONCRYL PDX-7780”, “JONCRYL 89-E” or “JONCRYL 89J” (manufactured by BASF Japan Ltd.).

Besides the vinyl polymers described above, a halogenated vinyl polymer (A2) having a glass transition temperature of 50° C. to 100° C. can be used as the vinyl polymer (A) used in the primer for ink-jet printing inks according to the present invention.

From the viewpoint that an ink-jet printing ink wets and spreads on a surface of a layer (z2) described later, and consequently, the generation of streaks is effectively suppressed, the vinyl polymer (A2) used has a glass transition temperature in the range of 50° C. or higher and 100° C. or lower, preferably in the range of 50° C. or higher and 80° C. or lower, and more preferably in the range of 55° C. or higher and 70° C. or lower.

For example, a vinyl chloride polymer, a chlorinated polyolefin, or chlorinated rubber can be used as the halogenated vinyl polymer (A2).

From the viewpoint of more effectively suppressing the generation of streaks, specifically, a vinyl chloride-acrylic polymer having a structural unit derived from a vinyl chloride monomer and a structural unit derived from a (meth)acrylic monomer other than the vinyl chloride monomer is preferably used as the halogenated vinyl polymer (A2).

The (meth)acrylic monomer other than the vinyl chloride monomer may be the same as the (meth)acrylic monomer other than the aromatic vinyl monomer, the (meth)acrylic monomer being described as an example of the monomer that can be used in the production of the vinyl polymer (A1).

The halogenated vinyl polymer (A2) used preferably has the structural unit derived from a halogenated vinyl monomer in an amount of 30% by mass to 90% by mass, more preferably 50% by mass to 80% by mass, relative to the total of the halogenated vinyl polymer (A2).

The halogenated vinyl polymer (A2) used preferably has a structural unit derived from a (meth)acrylic monomer other than the halogenated vinyl monomer in an amount of 10% by mass to 70% by mass, more preferably 20% by mass to 50% by mass, relative to the total of the halogenated vinyl polymer (A2).

Among the above vinyl polymers, a vinyl polymer having a core-shell structure is preferably used as the halogenated vinyl polymer (A2) from the viewpoint of more effectively suppressing the generation of streaks.

An example of the vinyl polymer having a core-shell structure may be a vinyl polymer in which the structural unit derived from a halogenated vinyl monomer is localized in a core portion and the structural unit derived from a (meth)acrylic monomer other than the halogenated vinyl monomer is localized in a shell portion. In particular, as the vinyl polymer having a core-shell structure, it is possible to use a vinyl polymer in which the amount of structural unit derived from a halogenated vinyl monomer and present in the core portion is preferably in the range of 90% by mass to 100% by mass, more preferably 95% by mass to 100% by mass, relative to the total amount of the structural unit derived from the halogenated vinyl monomer.

As the vinyl polymer having a core-shell structure, it is possible to use a vinyl polymer in which the amount of structural unit derived from a (meth)acrylic monomer other than the halogenated vinyl monomer and present in the shell portion is preferably in the range of 0% by mass to 10% by mass, more preferably 0% by mass to 5% by mass, relative to the total amount of the structural unit derived from the (meth)acrylic monomer.

The halogenated vinyl polymer (A2) can be produced by polymerizing the above-described monomers by, for example, an emulsion polymerization method, a solution polymerization method, a suspension polymerization method, or a bulk polymerization method. In the halogenated vinyl polymer (A2), the vinyl polymer having a core-shell structure can be produced by, for example, polymerizing a monomer component containing a (meth)acrylic monomer other than the halogenated vinyl monomer, the monomer component being capable of constituting the shell portion, by the above method to produce a polymer (x) constituting a shell, and subsequently supplying, for example, a halogenated vinyl monomer capable of forming the core portion to a reaction vessel to cause polymerization in the particles of the polymer (x).

The halogenated vinyl polymer (A2) used, the halogenated vinyl polymer (A2) being obtained by the above method, preferably has an acid value of 150 or less, more preferably has an acid value of 100 or less, more preferably has an acid value of 50 or less, and more preferably has an acid value in the range of 20 to 40 from the viewpoint of more effectively suppressing the generation of streaks.

The vinyl polymer (A2) used may be a commercially available product such as “Hi-Ros X BE7503” (manufactured by Seiko PMC Corporation), “VINYBLAN 745”, or “VINYBLAN 747” (manufactured by Nissin Chemical Industry Co., Ltd.).

The vinyl polymer (A) is preferably used in an amount in the range of 0.5% by mass to 5.0% by mass, particularly preferably in the range of 2.0% by mass to 3.0% by mass, relative to the total amount of the primer for ink-jet printing inks from the viewpoint of effectively suppressing generation of pinholes due to an ink-repellent phenomenon and achieving the effect of further suppressing the generation of streaks.

As the aqueous medium contained in the primer for ink-jet printing inks according to the present invention, for example, water can be used alone or a mixed solvent of water and an organic solvent described later can be used.

The water that can be used is specifically pure water such as ion-exchange water, ultrafiltration water, reverse osmosis water, or distilled water or ultrapure water.

The water is preferably used in an amount in the range of 1% by mass to 60% by mass, particularly preferably in the range of 30% by mass to 60% by mass, relative to the total amount of the primer for ink-jet printing inks from the viewpoint of obtaining a primer for ink-jet printing inks, the primer having high ejection stability required in the case of ejection by an ink-jet process, being capable of being relatively smoothly applied to a surface of the substrate (z1) and capable of forming a smooth layer (z2) to provide a clear printed material.

Examples of the organic solvent that can be used, as the aqueous medium, in combination with water include ketones such as acetone, methyl ethyl ketone, methyl butyl ketone, and methyl isobutyl ketone; alcohols such as methanol, ethanol, isopropyl alcohol, 1-propanol, 2-propanol, 2-methyl-1-propanol, 1-butanol, 2-butanol, and 2-methoxyethanol; ethers such as tetrahydrofuran, 1,4-dioxane, and 1,2-dimethoxyethane; dimethylformamide; N-methylpyrrolidone; glycols such as ethylene glycol, diethylene glycol, triethylene glycol, tetraethylene glycol, propylene glycol, polyethylene glycol, and polypropylene glycol; diols such as butanediol, pentanediol, hexanediol, and their homologue diols; glycol esters such as propylene glycol laurate; glycol ethers such diethylene glycol monoethyl ether, diethylene glycol monobutyl ether, and diethylene glycol monohexyl ether, propylene glycol ether, dipropylene glycol ether, and cellosolves including triethylene glycol ether; sulfolane; lactones such as γ-butyrolactone; lactams such as N-(2-hydroxyethyl)pyrrolidone; glycerin, diglycerin, polyglycerin, diglycerin fatty acid esters; polyoxypropylene(n)polyglyceryl ethers represented by general formula (1); and polyoxyethylene(n)polyglyceryl ethers represented by general formula (2). These organic solvents can be used alone or in combination of two or more thereof.

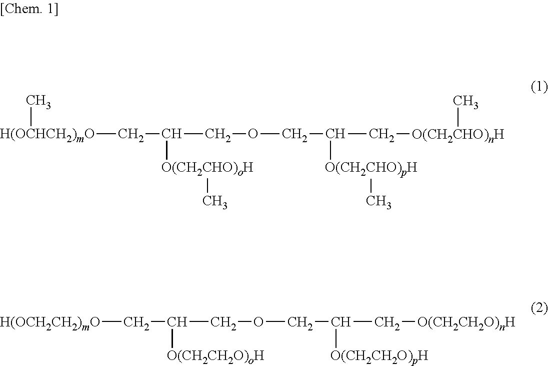

In general formula (1) and general formula (2), m, n, o, and p each independently represent an integer of 1 to 10.

Examples of the organic solvent include 3-methoxy-1-butanol, 3-methyl-3-methoxy-1-butanol, 3-methoxy-3-methyl-1-butyl acetate, ethylene glycol monomethyl ether, ethylene glycol monoethyl ether, ethylene glycol monopropyl ether, ethylene glycol monobutyl ether, ethylene glycol monoisobutyl ether, ethylene glycol-tert-butyl ether, propylene glycol monomethyl ether, propylene glycol monoethyl ether, propylene glycol monopropyl ether, propylene glycol monomethyl ether acetate, diethylene glycol dimethyl ether, diethylene glycol methyl ethyl ether, diethylene glycol diethyl ether, dipropylene glycol dimethyl ether, 4-methoxy-4-methyl-2-pentanone, and ethyl lactate. These organic solvents can be used alone or in combination of two or more thereof.

Next, a recording medium according to the present invention will be described.

A recording medium according to the present invention includes a substrate (z1) and a layer (z2) disposed on the whole or part of at least one surface of the substrate (z1) and formed from the primer for ink-jet printing inks. The recording medium having the layer (z2) can provide a printed material in which generation of streaks is suppressed without degrading setting properties, rubfastness, and water resistance compared with the substrate (z1) that does not have the layer (z2).

Examples of specific embodiments of the recording medium include a recording medium in which the layer (z2) is disposed on the whole surface at one side of the substrate (z1) either directly or with another layer interposed therebetween, and a recording medium in which the layer (z2) is disposed on the whole surface at each side of the substrate (z1) either directly or with another layer interposed therebetween.

Another specific embodiment of the recording medium is a recording medium in which the layer (z2) is disposed in regions where printing is to be performed with an ink-jet printing ink, the regions being located on one surface or both surfaces of the substrate (z1).

The recording medium can be produced by, for example, applying the primer for ink-jet printing inks according to the present invention to the whole or part of a substrate (z1) described later and drying the primer to form a layer (z2).

Examples of the substrate (z1) that can be used include non-absorbent substrates having no absorbency of ink-jet printing inks and poorly absorbent substrates having low absorbency of ink-jet printing inks.

In the present invention, since the layer (z2) is formed by using the primer described above, the substrate (z1) used may be one having an amount of water absorption of 10 g/m² or less when the substrate (z1) is brought into contact with water for 100 msec. Even in the case of using such a substrate (z1), the generation of streaks on a printed material can be effectively suppressed.

The amount of water absorption is an amount of water absorbed during contact with pure water for 100 ms at 23° C. and a relative humidity of 50%, the amount being measured by using an automatic scanning liquid absorptometer (KM500win, manufactured by Kumagai Riki Kogyo, Co., Ltd.). The measurement conditions are as follows.

[Spiral Method]

Contact Time: 0.010 to 1.0 (sec)

### Pitch: 7 (mm)

Length per sampling: 86.29 (degrees)

### Start Radius: 20 (mm)

### End Radius: 60 (mm)

### Min Contact Time: 10 (ms)

### Max Contact Time: 1000 (ms)

### Sampling Pattern: 50

Number of sampling points: 19

### [Square Head]

### Slit Span: 1 (mm)

### Width: 5 (mm)

Examples of the substrate (z1) that can be used include poorly absorbent substrates such as corrugated cardboard including a corrugated fluting medium and a liner bonded to one surface or both surfaces of the corrugated fluting medium, corrugated cardboard having, on a surface thereof, a color layer that is less likely to absorb a solvent in an ink-jet printing ink, art paper, e.g., paper for commercial printing, coated paper, lightweight coated paper, and ultra-lightweight coated paper. The poorly absorbent substrates that can be used are substrates produced by forming a coating layer by applying a coating material on the surface of high-quality or acid-free paper that is mainly formed of cellulose and is generally not subjected to surface treatment. Examples of the poorly absorbent substrates that can be used include ultra-lightweight coated paper such as “OK Ever Light Coat” manufactured by Oji Paper Co., Ltd. and “Aurora S” manufactured by Nippon Paper Industries Co., Ltd.; lightweight coated paper (A3) such as “OK Coat L” manufactured by Oji Paper Co., Ltd. and “Aurora L” manufactured by Nippon Paper Industries Co., Ltd.; coated paper (A2, B2) such as “OK Top Coat+(basis weight: 104.7 g/m², amount of water absorbed during contact time for 100 msec (hereinafter, the same applies to the amount of water absorption): 4.9 g/m²) manufactured by Oji Paper Co., Ltd., “Aurora Coat” manufactured by Nippon Paper Industries Co., Ltd., and UPM's Finesse Gloss (manufactured by UPM, 115 g/m², amount of water absorption: 3.1 g/m²) and Finess Matt (115 g/m², amount of water absorption: 4.4 g/m²); and art paper (A1) such as “OK Kinfuji+” manufactured by Oji Paper Co., Ltd. and “Tokubishi Art” manufactured by Mitsubishi Paper Mills Limited.

In particular, corrugated cardboard including a corrugated fluting medium and a liner bonded to one surface or both surfaces of the corrugated fluting medium or corrugated cardboard having the color layer can be suitably used as the substrate (z1). The corrugated cardboard may be, for example, single-faced corrugated cardboard, single-wall corrugated cardboard, double-wall corrugated cardboard, or triple-wall corrugated cardboard.

In the present invention, the formation of the layer (z2) using the primer for ink-jet printing inks enables an ink to easily wet and spread on the surface of the layer (z2). Accordingly, even in the case where a non-absorbent or poorly absorbent substrate is used as the substrate (z1), a printed material in which the generation of streaks is effectively suppressed can be obtained.

Examples of the method for applying the primer for ink-jet printing inks to the substrate (z1) include a roll coater method, a blade coater method, an air-knife coater method, a gate roll coater method, a bar coater method, a size press method, a spray coating method, a gravure coater method, a curtain coater method, a flexographic printing method, a screen printing method, a dispenser printing method, and an ink-jet printing method.

In the case where the layer (z2) is formed on part of the surface of the substrate (z1) included in the recording medium, the ink-jet printing method is preferably employed as the method for applying the primer for ink-jet printing inks. In such a case, the primer for ink-jet printing inks can be applied to the whole or part of the substrate (z1) by using an ink cartridge and an ink tank of an ink-jet printer, the ink cartridge and ink tank being filled with the primer.

The primer can be ejected onto the substrate (z1) by an ink-jet printing process in which a distance from an ink-jet head surface (x′) having ink ejection ports to a position (y′) at which a perpendicular of the surface (x′) intersects the surface of the substrate (z1) is 1 mm or more.

Such an ink-jet printing process in which the distance from the surface (x′) to the position (y′) at which an imaginary perpendicular with respect to the surface (x′) intersects the surface of the substrate (z1) is 1 mm or more, 2 mm or more, and further, 3 mm or more may be employed when, for example, the substrate (z1) is a large substrate that is easy to warp or a substrate having irregularities on a surface thereof.

The formation of the layer (z2) by application of the primer for ink-jet printing inks to part of the substrate (z) can reduce the amount of use of the primer for ink-jet printing inks.

The primer for ink-jet printing inks is preferably applied to the substrate (z1) in such an amount that the mass per unit area is in the range of 1 g/m² to 4 g/m² from the viewpoint of achieving the effect of preventing the generation of streaks on a printed material.

After the application of the primer for ink-jet printing inks by the method described above, the primer is dried as needed, to thereby form the layer (z2).

Examples of the drying method include methods using a method for drying with hot air, a method for drying by heating with infrared radiation or the like, or a method for drying under reduced pressure.

The drying conditions can be appropriately adjusted in accordance with film formability of the primer for ink-jet printing inks, the amount of the primer applied, or wettability of the primer that varies depending on the type of the substrate (z1). For example, the primer may be dried by allowing the applied primer to stand in an environment at room temperature (for example, 15° C. to 40° C.) for one second or more or dried by heating the applied primer to preferably 40° C. to 180° C.

The layer (z2) included in the recording medium obtained by the above method may be a layer that is sufficiently dried by the method or a tacky layer in a semi-dry state. Printing can be performed on either the dry layer or the layer in the semi-dry state by using an ink-jet printing ink described later. However, printing is preferably performed on the layer in the semi-dry state by using an ink-jet printing ink described later because good wettability of the ink-jet printing ink is easily ensured on the surface of the layer (z2), and the generation of streaks can be more effectively suppressed.

The layer in the semi-dry state may be, for example, a layer obtained by applying the primer for ink-jet printing inks to the surface of the substrate (z), and subsequently drying the primer under the conditions of 40° C. to 100° C. preferably for 60 seconds or less, more preferably 10 seconds or less, and still more preferably 1 second or more and 5 seconds or less.

In the layer (z2), the dry layer preferably has a mass per unit area in the range of 0.025 g/m² to 0.1 g/m², and more preferably in the range of 0.05 g/m² to 0.1 g/m² from the viewpoint of achieving the effect of preventing the generation of streaks on a printed material. The dry layer preferably has a thickness in the range of 0.01 μm to 0.3 μm, and more preferably in the range of 0.025 μm to 0.1 μm from the viewpoint of more effectively preventing the generation of streaks.

In the layer (z2), the tacky layer in the semi-dry state preferably has a mass per unit area in the range of 1 g/m² to 4 g/m², and more preferably in the range of 2 g/m² to 4 g/m² from the viewpoint of effectively suppressing generation of pinholes due to the ink-repellent phenomenon and more effectively suppressing the generation of streaks. The layer in the semi-dry state preferably has a thickness in the range of 1 μm to 6 μm.

The above-described recording medium according to the present invention can be suitably used when printing is performed by an ink-jet recording process in which a distance from an ink-jet head surface (x) having ink ejection ports to a position (y) at which a perpendicular of the surface (x) intersects the recording medium is 1 mm or more.

Next, a printing system according to the present invention will be described.

The printing system according to the present invention includes applying an ink-jet printing ink to the above-described recording medium by an ink-jet recording process in which a distance from an ink-jet head surface (x) having ink ejection ports to a position (y) at which a perpendicular of the surface (x) intersects a surface of the layer (z2) of the recording medium is 1 mm or more.

The printing system and a method for producing a printed material using the ink-jet recording process in which the distance from the surface (x) to the position (y) at which an imaginary perpendicular with respect to the surface (x) intersects the surface of the layer (z2) of the recording medium is 1 mm or more, 2 mm or more, and further, 3 mm or more may be employed when, for example, the recording medium is a large recording medium that is easy to warp or a recording medium having irregularities on a surface thereof. When the distance is increased to 1 mm or more, 2 mm or more, and further, 3 mm or more, ejected ink droplets tend to curve during the process of landing on the recording medium compared with the case where the distance is less than 1 mm, resulting in the tendency that streak-like patterns are likely to generate.

The recording medium according to the present invention is unlikely to generate white streak-like patterns on a printed material even when the lower limit of the distance is 1 mm or more, 2 mm or more, and further, 3 mm or more. The upper limit of the distance is preferably 10 mm or less, and particularly preferably 5 mm or less.

The ink-jet printing ink that can be used in the printing system preferably has, for example, a viscosity in the range of 2 mPa·s or more and less than 12 mPa·s and a surface tension of 20 mN/m to 40 mN/m and preferably has a viscosity in the range of 5 mPa·s or more and less than 8 mPa·s and a surface tension of 27 mN/m to 33 mN/m from the viewpoint of suppressing the generation of streaks.

The ink-jet printing ink that can be used is one containing, for example, a colorant such as a pigment or a dye, a pigment dispersant if a pigment is used, an aqueous medium, and as needed, optional components such as a surfactant, a binder resin, a compound having a urea bond, and an organic solvent.

The pigment is not particularly limited, and organic pigments or inorganic pigments that are commonly used in water-based gravure inks or water-based ink-jet printing inks can be used.

The pigment used may be a pigment that has not been subjected to acid treatment or a pigment that has been subjected to acid treatment.

Examples of the inorganic pigments that can be used include iron oxide and carbon black produced by a known method such as a contact method, a furnace method, or a thermal method.

Examples of the organic pigments that can be used include azo pigments (including, for example, azo lakes, insoluble azo pigments, condensed azo pigments, and chelate azo pigments); polycyclic pigments (such as phthalocyanine pigments, perylene pigments, perinone pigments, anthraquinone pigments, quinacridone pigments, dioxazine pigments, thioindigo pigments, isoindolinone pigments, and quinophthalone pigments); lake pigments (such as basic dye chelates and acidic dye chelates); nitro pigments; nitroso pigments; and aniline black.

Of the pigments, examples of the carbon black that can be used in black inks include carbon black manufactured by Mitsubishi Chemical Corporation such as No. 2300, No. 2200B, No. 900, No. 960, No. 980, No. 33, No. 40, No, 45, No. 45L, No. 52, HCF88, MA7, MA8, and MA100; carbon black manufactured by Columbia Carbon Company such as Raven 5750, Raven 5250, Raven 5000, Raven 3500, Raven 1255, and Raven 700; carbon black manufactured by Cabot Corporation such as Regal 400R, Regal 330R, Regal 660R, Mogul L, Mogul 700, Monarch 800, Monarch 880, Monarch 900, Monarch 1000, Monarch 1100, Monarch 1300, and Monarch 1400; and carbon black manufactured by Degussa AG such as Color Black FW1, FW2, FW2V, FW18, FW200, S150, S160, and S170, Printex 35, U, V, and 1400U, Special Black 6, 5, 4, and 4A, and NIPEX 150, NIPEX 160, NIPEX 170, and NIPEX 180.

Specific examples of pigments that can be used in yellow inks include C.I. Pigment Yellow 1, 2, 12, 13, 14, 16, 17, 73, 74, 75, 83, 93, 95, 97, 98, 109, 110, 114, 120, 128, 129, 138, 150, 151, 154, 155, 174, 180, and 185.

Specific examples of pigments that can be used in magenta inks include C.I. Pigment Red 5, 7, 12, 48(Ca), 48(Mn), 57(Ca), 57:1, 112, 122, 123, 146, 168, 176, 184, 185, 202, 209, 269, and 282 and C.I. Pigment Violet 19.

Specific examples of pigments that can be used in white inks include sulfates and carbonates of alkaline earth metals, silicas such as silicic acid fine powders and synthetic silicates, calcium silicate, alumina, hydrated alumina, titanium oxide, zinc oxide, talc, and clay. These pigments may be subjected to surface treatment.

Specific examples of pigments that can be used in cyan inks include C.I. Pigment blue 1, 2, 3, 15, 15:3, 15:4, 16, 22, 60, 63, and 66.

Measures for causing the pigment to be satisfactorily dispersed in an aqueous medium have been preferably taken in order to allow the pigment to be stably present in the ink.

Examples of the measures include:

(i) a method in which the pigment is dispersed in an aqueous medium together with a pigment dispersant by a dispersion method described later; and
(ii) a method in which a dispersibility-imparting group (a hydrophilic functional group and/or a salt thereof) is bound to the surface of the pigment either directly or indirectly with, for example, an alkyl group, an alkyl ether group, or an aryl group therebetween to prepare a self-dispersible pigment, and the self-dispersible pigment is dispersed and/or dissolved in an aqueous medium.

The self-dispersible pigment that can be used may be produced by, for example, subjecting a pigment to physical treatment or chemical treatment to bind (graft) a dispersibility-imparting group or an active species having a dispersibility-imparting group to the surface of the pigment. The self-dispersible pigment can be produced by, for example, vacuum plasma treatment, oxidation treatment with a hypohalous acid and/or a hypohalous acid salt, oxidation treatment with ozone, a wet oxidation method in which the surface of the pigment is oxidized by using an oxidizing agent in water, or a method in which p-aminobenzoic acid is bound to the surface of the pigment to thereby bind a carboxyl group with a phenyl group therebetween.

Since a water-based ink-jet printing ink containing the self-dispersible pigment need not contain the pigment dispersant, foaming or the like due to the pigment dispersant hardly occurs, and an ink-jet printing ink having good ejection stability is easily prepared. In addition, since a water-based ink-jet printing ink containing the self-dispersible pigment is easily handled and a significant increase in viscosity due to the pigment dispersant is prevented, the water-based ink-jet printing ink can contain a larger amount of the pigment. Accordingly, the water-based ink-jet printing ink can be used for producing printed materials having a high printing density.

A commercially available self-dispersible pigment may also be used. Examples of the commercially available product include MICROJET CW-1 (trade name; manufactured by Orient Chemical Industries Co., Ltd.), and CAB-O-JET 200 and CAB-O-JET 300 (trade names; manufactured by Cabot Corporation).

Examples of the colorant include disperse dyes, solvent dyes, vat dyes, direct dyes, acid dyes, food dye, basic dyes, reactive dyes, and available vat dyes. Typical examples of these dyes that can be used may be dyes selected from C.I. Disperse, C.I. Solvent, C.I. Vat, C.I. Direct, C.I. Acid, C.I. Food, C.I. Basic, C.I. Reactive, and C.I. Solubilised Vat, respectively.

In the present invention, if the composition of the ink-jet printing ink is excessively changed in order to prevent the generation of streaks, the printing density and rubfastness of printed materials tend to slightly decrease in some cases. The colorant (D) is preferably used in an amount in the range of 1% by mass to 20% by mass, and more preferably in the range of 2% by mass to 10% by mass relative to the total amount of the ink-jet printing ink from the viewpoint of preventing the generation of streaks, maintaining good dispersion stability of the colorant (D), and improving the printing density and rubfastness of printed materials.

(Pigment Dispersant)

The pigment dispersant can be suitably used when a pigment is used as the colorant.

Examples of the pigment dispersant that can be used include water-based resins such as polyvinyl alcohols; polyvinylpyrrolidones; acrylic resins such as acrylic acid-acrylate copolymers; styrene-acrylic resins such as styrene-acrylic acid copolymers, styrene-methacrylic acid copolymers, styrene-methacrylic acid-acrylate copolymers, styrene-α-methylstyrene-acrylic acid copolymers, and styrene-α-methylstyrene-acrylic acid-acrylate copolymers; styrene-maleic acid copolymers; styrene-maleic anhydride copolymers; and vinylnaphthalene-acrylic acid copolymers; and salts of these water-based resins. Examples of the pigment dispersant that can be used further include AJISPER PB series manufactured by Ajinomoto Fine-Techno Co., Inc., Disperbyk series manufactured by BYK-Chemie Japan, EFKA series manufactured by BASF, SOLSPERSE series manufactured by The Lubrizol Corporation, and TEGO series manufactured by EVONIK.

A polymer (G) described below may also be used as the pigment dispersant from the viewpoint of being capable of significantly reducing coarse particles, and consequently imparting good ejection stability required when the ink-jet printing ink in the present invention is ejected by an ink-jet process.

A polymer having anionic groups can be used as the polymer (G). In particular, it is preferable to use a polymer which has a solubility of 0.1 g/100 mL or less in water, which can form fine particles in water when a neutralization rate of the anionic groups achieved with a basic compound is 100%, and which has a number-average molecular weight in the range of 1,000 to 6,000.

The solubility of the polymer (G) in water was defined as follows. A polymer was screened with sieves with mesh sizes of 250 μm and 90 μm such that the particle size was adjusted in the range of 250 μm to 90 μm. Subsequently, 0.5 g of the resulting polymer was enclosed in a bag obtained by processing a 400-mesh wire net to prepare a specimen (M). Next, the specimen (M) was immersed in 50 mL of water and left under gentle stirring at a temperature of 25° C. for 24 hours. After 24 hours, the specimen (M) was dried in a dryer set at 110° C. for two hours. The change in the mass of the specimen (M) before and after the immersion in water was measured, and the solubility was calculated by using the following formula.

Solubility (g/100 mL)=[(mass (g) of specimen (M) before immersion in water)−(mass (g) of specimen (M) after immersion in water)]×2

In the present invention, whether or not fine particles are formed in water when the neutralization rate of the anionic groups achieved with the basic compound is 100% was determined as follows.

(1) The acid value of the polymer (G) is measured in advance by the method for measuring an acid value in accordance with JIS test method K 0070-1992. Specifically, 0.5 g of the polymer (G) is dissolved in tetrahydrofuran, and titration is performed with a 0.1M alcohol solution of potassium hydroxide by using phenolphthalein as an indicator to determine the acid value.
(2) To 50 mL of water, 1 g of the polymer (G) is added, and a 0.1 mol/L aqueous potassium hydroxide solution is then added to the mixture in an amount required for neutralizing 100% of the acid value determined above to achieve a neutralization rate of 100%.
(3) The resulting liquid having a neutralization rate of 100% was subjected to ultrasonic waves at a temperature of 25° C. for two hours by using an ultrasonic cleaner (ultrasonic cleaner US-102, SND Company Limited, 38 kHz, self-excited oscillation) and is then left to stand at room temperature for 24 hours.

After the solution is left to stand for 24 hours, a sample solution is sampled at a depth of 2 centimeters from the surface of the solution. Subsequently, for the sample solution, whether or not information about light scattering due to the formation of fine particles is obtained is determined by using a dynamic light scattering particle size distribution measuring apparatus (dynamic light scattering particle size measuring apparatus “Microtrac particle size distribution analyzer UPA-ST150” manufactured by NIKKISO Co., Ltd.). The presence of fine particles is thereby examined.

In order to further improve stability in water of the fine particles formed from the polymer (G) used in the present invention, the fine particles preferably have a particle size in the range of 5 nm to 1,000 nm, more preferably in the range of 7 nm to 700 nm, and most preferably in the range of 10 nm to 500 nm. As the particle size distribution of the fine particles becomes narrower, the fine particles tend to exhibit better dispersion stability. However, even in the case of a wide particle size distribution, an ink-jet printing ink having better dispersion stability than existing inks can be obtained. The particle size and the particle size distribution were measured by using a dynamic light scattering particle size distribution measuring apparatus (dynamic light scattering particle size measuring apparatus “Microtrac particle size distribution analyzer UPA-ST150” manufactured by NIKKISO Co., Ltd.).

The neutralization rate of the polymer (G) used in the present invention was determined by using the following formula.

Neutralization rate (%)=[(mass (g) of basic compound×56 ×1,000)/(acid value (mgKOH/g) of polymer (G)×equivalent of basic compound×mass (g) of polymer (G))]×100

The acid value of the polymer (G) was measured in accordance with JIS test method K 0070-1992. Specifically, 0.5 g of a sample was dissolved in tetrahydrofuran, and titration was performed with a 0.1M alcohol solution of potassium hydroxide by using phenolphthalein as an indicator.

The polymer (G) used preferably has a number-average molecular weight in the range of 1,000 to 6,000, more preferably 1,300 to 5,000, and more preferably 1,500 to 4,500 from the viewpoint that, for example, aggregation of a colorant such as a pigment in the aqueous medium can be effectively suppressed, and an ink-jet printing ink having good dispersion stability of the colorant is obtained.

The number-average molecular weight is a polystyrene-equivalent value measured by GPC (gel permeation chromatography) and is specifically a value measured under the conditions described below.

### (Method for Measuring Number-Average Molecular Weight (Mn))

The measurement was performed by gel permeation chromatography (GPC) under the following conditions.

Measurement apparatus: High performance GPC (“HLC-8220GPC” manufactured by Tosoh Corporation)
Columns: The following columns manufactured by Tosh Corporation were connected in series and used.

“TSKgel G5000” (7.8 mm I.D.×30 cm)×1

“TSKgel G4000” (7.8 mm I.D.×30 cm)×1

“TSKgel G3000” (7.8 mm I.D.×30 cm)×1

“TSKgel G2000” (7.8 mm I.D.×30 cm)×1

Detector: RI (refractive index detector)
Column temperature: 40° C.

### Eluent: Tetrahydrofuran

Flow rate: 1.0 mL/minute
Amount of injection: 100 μL (tetrahydrofuran solution having a sample concentration of 0.4% by mass)
Standard samples: The following standard polystyrenes were used to prepare a calibration curve.

### (Standard Polystyrenes)

“TSKgel standard polystyrene A-500” manufactured by Tosoh Corporation

“TSKgel standard polystyrene A-1000” manufactured by Tosoh Corporation

“TSKgel standard polystyrene A-2500” manufactured by Tosoh Corporation

“TSKgel standard polystyrene A-5000” manufactured by Tosoh Corporation

“TSKgel standard polystyrene F-1” manufactured by Tosoh Corporation

“TSKgel standard polystyrene F-2” manufactured by Tosoh Corporation

“TSKgel standard polystyrene F-4” manufactured by Tosoh Corporation

“TSKgel standard polystyrene F-10” manufactured by Tosoh Corporation

“TSKgel standard polystyrene F-20” manufactured by Tosoh Corporation

“TSKgel standard polystyrene F-40” manufactured by Tosoh Corporation

“TSKgel standard polystyrene F-80” manufactured by Tosoh Corporation

“TSKgel standard polystyrene F-128” manufactured by Tosoh Corporation

“TSKgel standard polystyrene F-288” manufactured by Tosoh Corporation

“TSKgel standard polystyrene F-550” manufactured by Tosoh Corporation

The surface tension of the ink-jet printing ink containing the polymer (G) is preferably 30 dyn/cm or more, more preferably 40 dyn/cm or more, and particularly preferably 65 dyn/cm to 75 dyn/cm, which is close to the surface tension of water. The surface tension refers to a value measured for a polymer solution prepared by adding 1 g of the polymer (G) in water, and then adding a 0.1 mol/L aqueous potassium hydroxide solution in an amount required for neutralizing 100% of the predetermined acid value to achieve a neutralization rate of 100%.

As the polymer (G), it is possible to use a polymer that is insoluble or poorly soluble in water when not neutralized and that forms fine particles when a neutralization rate of 100% is achieved. The polymer (G) is not particularly limited as long as the polymer has, in one molecule thereof, a hydrophobic group besides an anionic group, which is a hydrophilic group.

Examples of such a polymer include block polymers including a polymer block having hydrophobic groups and a polymer block having anionic groups. In the polymer (G), the number of anionic groups and the solubility in water are not necessarily specified by the acid value of the polymer or the number of anionic groups at the time of the design of the polymer. For example, even among polymers having the same acid value, a polymer having a low molecular weight tends to have a high solubility in water, and a polymer having a high molecular weight tends to have a low solubility in water. Therefore, in the present invention, the polymer (G) is specified by its solubility in water.

The polymer (G) may be a homopolymer but is preferably a copolymer. The polymer (G) may be a random polymer, a block polymer, or an alternating polymer. Among these, a block polymer is preferred. The polymer may be a branched polymer but is preferably a linear polymer.

The polymer (G) is preferably a vinyl polymer in view of design flexibility. The method for producing a vinyl polymer having a molecular weight and solubility characteristics desired in the present invention is preferably a method using “living polymerization” such as living radical polymerization, living cationic polymerization, or living anionic polymerization.

In particular, the polymer (G) is preferably a vinyl polymer produced by using a (meth)acrylate monomer as one of the raw materials. The method for producing such a vinyl polymer is preferably living radical polymerization or living anionic polymerization. Furthermore, from the viewpoint that the molecular weight of the block polymer and each segment thereof can be more precisely designed, living anionic polymerization is preferred.

Specifically, the polymer (G) produced by living anionic polymerization is a polymer represented by general formula (3).

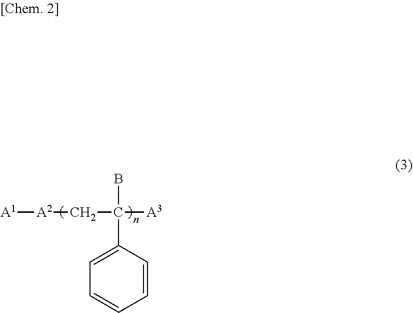

In general formula (3), A¹ represents an organolithium initiator residue, A² represents a polymer block of a monomer having an aromatic ring or a heterocycle, A³ represents a polymer block containing an anionic group, n represents an integer of 1 to 5, and B represents an aromatic group or an alkyl group.

In general formula (3), A¹ represents an organolithium initiator residue. Specific examples of the organolithium initiator include alkyl lithiums such as methyllithium, ethyllithium, propyllithium, butyllithium (e.g., n-butyllithium, sec-butyllithium, iso-butyllithium, and tert-butyllithium), pentyllithium, hexyllithium, methoxymethyllithium, and ethoxymethyllithium; phenylalkylenelithiums such as benzyllithium, α-methylstyryllithium, 1,1-diphenyl-3-methylpentyllithium, 1,1-diphenylhexyllithium, and phenylethyllithium; alkenyllithiums such as vinyllithium, allyllithium, propenyllithium, and butenyllithium; alkynyllithiums such as ethynyllithium, butynyllithium, pentynyllithium, and hexynyllithium; aryllithiums such as phenyllithium and naphthyllithium; heterocyclic lithiums such as 2-thienyllithium, 4-pyridyllithium, and 2-quinolyllithium; and alkyl lithium-magnesium complexes such as tri(n-butyl)magnesium lithium and trimethyl magnesium lithium.

In the organolithium initiator, the bond between the organic group and lithium is cleaved, and an active end is thereby formed in the organic group. Polymerization is initiated from the active end. Therefore, the organic group derived from the organolithium is bound to an end of the resulting polymer. In the present invention, the organic group derived from the organolithium and bound to the end of the polymer is referred to as the organolithium initiator residue. For example, in a polymer produced by using methyllithium as the initiator, the organolithium initiator acid group is a methyl group. In a polymer produced by using butyllithium as the initiator, the organolithium initiator acid group is a butyl group.

In general formula (3), A² represents a polymer block having hydrophobic groups. A² is a group provided for the purpose of achieving the appropriate balance of solubility as described above and is preferably a group that exhibits high adsorptivity for the pigment when comes in contact with the pigment. From this point of view, A² is preferably a polymer block of a monomer having an aromatic ring or a heterocycle.

The polymer block of a monomer having an aromatic ring or a heterocycle is specifically a homopolymer or copolymer block obtained by homopolymerization or copolymerization of a monomer having an aromatic ring such as a styrene-based monomer or a monomer having a heterocycle such as a vinylpyridine-based monomer.

Examples of the monomer having an aromatic ring include styrene-based monomers such as styrene, p-tert-butyldimethylsiloxystyrene, o-methylstyrene, p-methylstyrene, p-tert-butylstyrene, p-tert-butoxystyrene, m-tert-butoxystyrene, p-tert-(1-ethoxymethyl)styrene, m-chlorostyrene, p-chlorostyrene, p-fluorostyrene, α-methylstyrene, and p-methyl-α-methylstyrene; vinylnaphthalene; and vinylanthracene.

Examples of the monomer having a heterocycle include vinylpyridine-based monomers such as 2-vinylpyridine and 4-vinylpyridine. These monomers may be used alone or as a mixture of two or more thereof.

In general formula (3) above, A³ represents a polymer block containing an anionic group. A³ is provided for the purpose of providing appropriate solubility as described above and for the purpose of imparting dispersion stability in water when a pigment dispersion is formed.

Examples of the anionic group in the polymer block A³ include a carboxyl group, a sulfonic acid group, and a phosphate group. Of these, a carboxyl group is preferred in view of preparation thereof, a wide range of types of monomers, and availability. Two carboxyl groups may be intramolecularly or intermolecularly subjected to dehydration-condensation to form an acid anhydride group.

The method for introducing an anionic group into A³ is not particularly limited. For example, when the anionic group is a carboxyl group, A³ may be a homopolymer or copolymer block (PB1) obtained by homopolymerization of (meth)acrylic acid or by copolymerization of (meth)acrylic acid with another monomer or may be a polymer block (PB2) obtained by homopolymerization of a (meth)acrylate having a protecting group that can be regenerated into an anionic group by deprotection or by copolymerization of such a (meth)acrylate with another monomer to obtain a homopolymer or a copolymer and then partially or entirely regenerating the protecting groups that can be regenerated into anionic groups into the anionic groups.

Note that the term “(meth)acrylic acid” used in the polymer block A³ collectively refers to acrylic acid and methacrylic acid, and the term “(meth)acrylate” used in the polymer block A³ collectively refers to an acrylate and a methacrylate.

Specific examples of the (meth)acrylic acid and (meth)acrylate include (meth)acrylic acid, methyl (meth)acrylate, ethyl (meth)acrylate, iso-propyl (meth)acrylate, allyl (meth)acrylate, n-butyl (meth)acrylate, iso-butyl (meth)acrylate, sec-butyl (meth)acrylate, tert-butyl (meth)acrylate, n-amyl (meth)acrylate, iso-amyl (meth)acrylate, n-hexyl (meth)acrylate, n-octyl (meth)acrylate, 2-ethylhexyl (meth)acrylate, n-lauryl (meth)acrylate, n-tridecyl (meth)acrylate, n-stearyl (meth)acrylate, phenyl (meth)acrylate, benzyl (meth)acrylate, cyclohexyl (meth)acrylate, 4-tert-butylcyclohexyl (meth)acrylate, isobornyl (meth)acrylate, tricyclodecanyl (meth)acrylate, dicyclopentadienyl (meth)acrylate, adamantyl (meth)acrylate, glycidyl (meth)acrylate, tetrahydrofurfuryl (meth)acrylate, 2-methoxyethyl (meth)acrylate, 2-ethoxyethyl (meth)acrylate, dimethylaminoethyl (meth)acrylate, diethylaminoethyl (meth)acrylate, trifluoroethyl (meth)acrylate, tetrafluoropropyl (meth)acrylate, pentafluoropropyl (meth)acrylate, octafluoropentyl (meth)acrylate, pentadecafluorooctyl (meth)acrylate, heptadecafluorodecyl (meth)acrylate, N,N-dimethyl(meth)acrylamide, (meth)acryloylmorpholine, (meth)acrylonitrile, and polyalkylene oxide group-containing (meth)acrylates such as polyethylene glycol (meth)acrylate, polypropylene glycol (meth)acrylate, polyethylene glycol-polypropylene glycol (meth)acrylate, polyethylene glycol-polybutylene glycol (meth)acrylate, polypropylene glycol-polybutylene glycol (meth)acrylate, methoxypolyethylene glycol (meth)acrylate, ethoxypolyethylene glycol (meth)acrylate, butoxypolyethylene glycol (meth)acrylate, octoxypolyethylene glycol (meth)acrylate, lauroxypolyethylene glycol (meth)acrylate, stearoxypolyethylene glycol (meth)acrylate, phenoxypolyethylene glycol (meth)acrylate, methoxypolypropylene glycol (meth)acrylate, and octoxypolyethylene glycol-polypropylene glycol (meth)acrylate. These monomers may be used alone or as a mixture of two or more thereof.

In the living anionic polymerization method, when the monomer used is a monomer having an active proton-containing group such as an anionic group, an active end of the living anionically polymerized polymer immediately reacts with the active proton-containing group and is deactivated, and thus no polymer is produced. In living anionic polymerization, it is difficult to polymerize such a monomer having an active proton-containing group without further treatment. Therefore, preferably, polymerization is performed while the active proton-containing group is protected, and the protecting group is then deprotected to thereby regenerate the active proton-containing group.

For this reason, it is preferable to use, for the polymer block A³, a monomer including a (meth)acrylate having a protecting group that can be regenerated into an anionic group by deprotection. The use of such a monomer enables the inhibition of polymerization to be prevented during polymerization. The anionic group protected by the protecting group can be regenerated into the anionic group by deprotection after a block polymer is obtained.

For example, when the anionic group is a carboxyl group, the carboxyl group is esterified, deprotection is performed by hydrolysis or the like in the subsequent step, and the esterified carboxyl group can be thereby regenerated into a carboxyl group. In this case, the protecting group that can be converted into the carboxyl group is preferably a group having an ester bond. Examples of such a group include primary alkoxycarbonyl groups such as a methoxycarbonyl group, an ethoxycarbonyl group, a n-propoxycarbonyl group, and a n-butoxycarbonyl group; secondary alkoxycarbonyl groups such as an isopropoxycarbonyl group and a sec-butoxycarbonyl group; tertiary alkoxycarbonyl groups such as a tert-butoxycarbonyl group; phenylalkoxycarbonyl groups such as a benzyloxycarbonyl group; and alkoxyalkylcarbonyl groups such as an ethoxyethylcarbonyl group.

Examples of the monomer that can be used when the anionic group is a carboxyl group include alkyl (meth)acrylates such as methyl (meth)acrylate, ethyl (meth)acrylate, n-propyl (meth)acrylate, isopropyl (meth)acrylate, n-butyl (meth)acrylate, sec-butyl (meth)acrylate, isobutyl (meth)acrylate, tert-butyl (meth)acrylate, 2-ethylhexyl (meth)acrylate, decyl (meth)acrylate, undecyl (meth)acrylate, dodecyl (meth)acrylate (lauryl (meth)acrylate), tridecyl (meth)acrylate, pentadecyl (meth)acrylate, hexadecyl (meth)acrylate, heptadecyl (meth)acrylate, octadecyl (meth)acrylate (stearyl (meth)acrylate), nonadecyl (meth)acrylate, and icosanyl (meth)acrylate; phenylalkylene (meth)acrylates such as benzyl (meth)acrylate; and alkoxyalkyl (meth)acrylates such as ethoxyethyl (meth)acrylate. These (meth)acrylates may be used alone or in combination of two or more thereof. Of these (meth)acrylates, tert-butyl (meth)acrylate and benzyl (meth)acrylate are preferably used because the conversion reaction to a carboxyl group is easily performed. In view of industrial availability, tert-butyl (meth)acrylate is more preferred.

In general formula (3), B represents an aromatic group or an alkyl group having 1 to 10 carbon atoms, and n represents an integer of 1 to 5.

In the living anionic polymerization method, in the case of direct polymerization of a (meth)acrylate monomer at an active end of a highly nucleophilic styrene-based polymer, polymerization may not proceed due to nucleophilic attack to the carbonyl carbon. Therefore, when the A¹-A² is polymerized with the (meth)acrylate monomer, a reaction control agent is used to control nucleophilicity, and the (meth)acrylate monomer is then polymerized. In general formula (3), B is a group derived from the reaction control agent. Specific examples of the reaction control agent include diphenylethylene, α-methylstyrene, and p-methyl-α-methylstyrene.

When the reaction conditions are appropriately controlled, the living anionic polymerization method can be performed as a batch process as used in existing free-radical polymerization. Alternatively, a continuous polymerization method using a microreactor may also be employed. In the microreactor, since a polymerization initiator and a monomer are satisfactorily mixed, the reaction starts at the same time. Furthermore, since the temperature is uniform in the microreactor to make the rate of polymerization uniform, the polymer produced can have a narrow molecular-weight distribution. In addition, it is easy to produce a block copolymer in which two components of the blocks are not mixed with each other because the growing ends are stable. Furthermore, since the reaction temperature is easily controlled, the occurrence of side reactions can be easily reduced.

A first monomer and a polymerization initiator for initiating polymerization are introduced through tube reactors P1 and P2 into a T-shaped micromixer M1 including a flow passage in which a plurality of liquids can be mixed. The first monomer is subjected to living anionic polymerization in the T-shaped micromixer M1 to form a first polymer (step 1).

Next, the resulting first polymer is transferred to a T-shaped micromixer M2. In the mixer M2, the growing ends of the obtained polymer are trapped with a reaction control agent introduced from a tube reactor P3 to control the reaction (step 2).

The number denoted by n in general formula (3) above can be controlled by changing the type or amount of the reaction control agent used in this case.

Next, the first polymer, which has been subjected to reaction control in the T-shaped micromixer M2, is transferred to a T-shaped micromixer M3. In the mixer M3, a second monomer introduced from a tube reactor P4 and the first polymer, which has been subjected to reaction control, are continuously subjected to living anionic polymerization (step 3).

Subsequently, the reaction is quenched with an active proton-containing compound such as methanol. Thus, a block copolymer is produced.

When the polymer (G) in the present invention represented by general formula (3) is produced by using the microreactor described above, a monomer having an aromatic ring or a heterocycle is used as the first monomer, and an organolithium initiator is used as the initiator to cause the reaction. A polymer block of the monomer having an aromatic ring or a heterocycle, that is, A² described above, (an organic group that is the organolithium initiator residue represented by A¹ is bound to an end of the polymer block A²) is thereby obtained.

Next, the reactivity of the growing ends is controlled by using the reaction control agent. Subsequently, a monomer including a (meth)acrylate having a protecting group that can be regenerated into the anionic group is caused to react as the second monomer to obtain another polymer block.

Subsequently, the protecting group is regenerated into the anionic group by a deprotection reaction such as hydrolysis. Thus, A³ described above, that is, a polymer block containing the anionic group, is obtained.

A detailed description will be made of the method for regenerating an ester bond in the protecting group that can be regenerated into the anionic group into the anionic group by a deprotection reaction such as hydrolysis.

Although the hydrolysis reaction of the ester bond proceeds under either acidic conditions or basic conditions, the conditions vary slightly depending on the type of ester bond-containing group. For example, when the ester bond-containing group is a primary alkoxycarbonyl group such as a methoxycarbonyl group or a secondary alkoxycarbonyl group such as an isopropoxycarbonyl group, a carboxyl group can be obtained by hydrolysis under basic conditions. Examples of a basic compound used for producing the basic conditions in this case include metal hydroxides such as sodium hydroxide and potassium hydroxide.

When the ester bond-containing group is a tertiary alkoxycarbonyl group such as a tert-butoxycarbonyl group, a carboxyl group can be obtained by hydrolysis under acidic conditions. Examples of an acidic compound used for producing the acidic conditions in this case include mineral acids such as hydrochloric acid, sulfuric acid, and phosphoric acid; Brønsted acids such as trifluoroacetic acid; and Lewis acids such as trimethylsilyl triflate. The reaction conditions of hydrolysis of a tert-butoxycarbonyl group under acidic conditions are disclosed in, for example, “Synthesis of Organic Compounds IV, The Fifth Series of Experimental Chemistry Vol. 16, edited by The Chemical Society of Japan”.

Another method for converting the tert-butoxycarbonyl group into a carboxyl group is a method in which a cation exchange resin is used instead of the acid described above. Examples of the cation exchange resin include resins having an acid group such as a carboxyl group (—COOH) or a sulfo group (—SO₃H) in a polymer side chain thereof. Of these, a strongly acidic cation exchange resin having a sulfo group in a side chain thereof is preferable because the reaction can be caused to proceed rapidly. Examples of the commercially available product of the cation exchange resin that can be used in the present invention include strongly acidic cation exchange resin “Amberlite” manufactured by Organo Corporation. The amount of the cation exchange resin used is preferably in the range of 5 parts by mass to 200 parts by mass, more preferably in the range of 10 parts by mass to 100 parts by mass, relative to 100 parts by mass of the polymer represented by general formula (3) above because hydrolysis can be effectively performed.

When the ester bond-containing group is a phenylalkoxycarbonyl group such as a benzyloxycarbonyl group, the phenylalkoxycarbonyl group can be converted into a carboxyl group through a hydrogenation reduction reaction. In this case, the phenylalkoxycarbonyl group can be quantitatively regenerated into a carboxyl group by causing the phenylalkoxycarbonyl group to react under the condition of room temperature by using hydrogen gas as a reducing agent in the presence of a palladium catalyst such as palladium acetate.

As described above, the reaction conditions for conversion into a carboxyl group vary depending on the type of ester bond-containing group. For example, a polymer produced by copolymerization using tert-butyl (meth)acrylate and n-butyl (meth)acrylate as raw materials of A³ has tert-butoxycarbonyl groups and n-butoxycarbonyl groups. Under the acidic conditions under which the tert-butoxycarbonyl groups are hydrolyzed, the n-butoxycarbonyl groups are not hydrolyzed. Accordingly, only the tert-butoxycarbonyl groups are selectively hydrolyzed, which enables the tert-butoxycarbonyl groups to be deprotected and regenerated into carboxyl groups. Therefore, the acid value of the hydrophilic block (A³) can be adjusted by appropriately selecting, as a raw material monomer of A³, a monomer including a (meth)acrylate having a protecting group that can be regenerated into an anionic group.

In the polymer (G) represented by general formula (3) above, it is advantageous that the polymer block (A²) and the polymer block (A³) form a block copolymer in which the polymer blocks each forming a unit having a certain length are regularly bound together, rather than a random copolymer in which the polymer blocks are bound together in a random arrangement, from the viewpoint of improving stability of an aqueous pigment dispersion in which the pigment is dispersed in water by the polymer (G). The aqueous pigment dispersion is a raw material used to produce an ink-jet printing ink and is a liquid in which the pigment described above is dispersed in water in a high concentration by using the polymer (G). The molar ratio A²:A³ of the polymer block (A²) to the polymer block (A³) is preferably in the range of 100:10 to 100:500, and the molar ratio A²:A³ is more preferably 100:10 to 100:450 from the viewpoint of, for example, being capable of maintaining good ejection stability required when an ink is ejected by an ink-jet process and obtaining an ink-jet printing ink that can produce printed materials with, for example, better color development.

In the polymer (G) represented by general formula (3) above, the number of monomers having an aromatic ring or a heterocycle, which constitutes the polymer block (A²), is preferably in the range of 5 to 40, more preferably in the range of 6 to 30, and most preferably in the range of 7 to 25. The number of anionic groups constituting the polymer block (A³) is preferably in the range of 3 to 20, more preferably in the range of 4 to 17, and most preferably in the range of 5 to 15.

When the molar ratio A²:A³ of the polymer block (A²) to the polymer block (A³) is expressed by the molar ratio of the number of moles of the aromatic ring or the heterocycle constituting the polymer block (A²) to the number of moles of the anionic group constituting (A³), this molar ratio is preferably 100:7.5 to 100:400.

The acid value of the polymer (G) represented by general formula (3) above is preferably 40 mgKOH/g to 400 mgKOH/g, more preferably 40 mgKOH/g to 300 mgKOH/g, and most preferably 40 mgKOH/g to 190 mgKOH/g from the viewpoint of, for example, being capable of maintaining good ejection stability required when an ink is ejected by an ink-jet process and obtaining an ink-jet printing ink that can produce printed materials better in terms of, for example, rubfastness. The acid value was measured by the same method as the method for measuring an acid value, the method being described in the method for determining “whether or not fine particles are formed in water when the neutralization rate of the anionic groups achieved with the basic compound is 100%”.

In the ink-jet printing ink in the present invention, the anionic groups included in the polymer (G) are preferably neutralized.

Any publicly known and commonly used basic compound can be used as the basic compound for neutralizing the anionic groups in the polymer (G). For example, inorganic basic substances such as alkali metal hydroxides, e.g., sodium hydroxide and potassium hydroxide, and organic basic compounds such as ammonia, triethylamine, and alkanolamines can be used.

The degree of neutralization of the polymer (G) present in the aqueous pigment dispersion is not necessarily 100% relative to the acid value of the polymer. Specifically, the anionic groups are neutralized such that the neutralization rate of the polymer (G) is preferably 20% to 200%, more preferably 80% to 150%.

The ink-jet printing ink in the present invention may contain, besides the components described above, other additives such as a surfactant, a humectant (drying inhibitor), a penetrant, a preservative, a viscosity modifier, a pH adjuster, a chelating agent, a plasticizer, an antioxidant, and an ultraviolet absorber, as required.

The surfactant can be used to improve levelling properties of the ink-jet printing ink by, for example, decreasing the surface tension of the ink-jet printing ink. Furthermore, the surfactant causes the ink-jet printing ink to satisfactorily wet and spread on a surface of the layer (z2) of the recording medium after the ink-jet printing ink ejected from ejection ports of an ink-jet head is landed on the surface. Thus, the generation of streaks on a printed material can be prevented.

Examples of the surfactant include anionic surfactants, nonionic surfactants, cationic surfactants, and amphoteric surfactants. Of these, anionic surfactants and nonionic surfactants are preferred.

Examples of the anionic surfactants include alkylbenzene sulfonates, alkylphenyl sulfonates, alkylnaphthalene sulfonates, higher fatty acid salts, sulfate ester salts of higher fatty acid esters, sulfonates of higher fatty acid esters, sulfate ester salts and sulfonates of higher alcohol ethers, higher alkyl sulfosuccinates, polyoxyethylene alkyl ether carboxylates, polyoxyethylene alkyl ether sulfates, alkyl phosphates, and polyoxyethylene alkyl ether phosphates. Specific examples of these anionic surfactants include dodecylbenzene sulfonate, isopropylnaphthalene sulfonate, monobutylphenylphenol monosulfonate, monobutylbiphenyl sulfonate, and dibutylphenylphenol disulfonate.

Examples of the nonionic surfactants that can be used include polyoxyethylene alkyl ethers, polyoxyethylene alkylphenyl ethers, polyoxyethylene fatty acid esters, sorbitan fatty acid esters, polyoxyethylene sorbitan fatty acid esters, polyoxyethylene sorbitol fatty acid esters, glycerin fatty acid esters, polyoxyethylene glycerin fatty acid esters, polyglycerin fatty acid esters, sucrose fatty acid esters, polyoxyethylene alkyl amines, polyoxyethylene fatty acid amides, fatty acid alkylolamides, alkyl alkanolamides, acetylene glycol, oxyethylene adducts of acetylene glycol, and polyethylene glycol-polypropylene glycol block copolymers. Of these, polyoxyethylene nonylphenyl ether, polyoxyethylene octylphenyl ether, polyoxyethylene dodecylphenyl ether, polyoxyethylene alkyl ethers, polyoxyethylene fatty acid esters, sorbitan fatty acid esters, polyoxyethylene sorbitan fatty acid esters, fatty acid alkylolamides, acetylene glycol, oxyethylene adducts of acetylene glycol, and polyethylene glycol-polypropylene glycol block copolymers are preferably used as the nonionic surfactants. In particular, acetylene glycol and oxyethylene adducts of acetylene glycol are more preferably used as the nonionic surfactants because the contact angle of a droplet of the ink-jet printing ink with respect to the layer (z2) of the recording medium is reduced, the ink easily wets and spreads on the surface of the recording medium, and consequently, printed materials in which the generation of streaks is more effectively suppressed are obtained.

Other surfactants, for example, silicone-based surfactants such as polysiloxane oxyethylene adducts; fluorine-based surfactants such as perfluoroalkyl carboxylates, perfluoroalkyl sulfonates, and oxyethylene perfluoroalkyl ethers; and biosurfactants such as spiculisporic acid, rhamnolipid, and lysolecithin may also be used.

A surfactant having an HLB in the range of 4 to 20 is preferably used as the surfactant from the viewpoint of stably maintaining a state in which the surfactant is dissolved in the ink-jet printing ink that contains water as a main solvent.

The surfactant is preferably used in an amount in the range of 0.001% by mass to 2% by mass, more preferably in the range of 0.001% by mass to 1.5% by mass, and preferably in the range of 0.5% by mass to 1.5% by mass relative to the total amount of the ink-jet printing ink. The ink-jet printing ink containing the surfactant in an amount in the above range is preferred because the ink has sufficient wettability of ejected droplets thereof on the surface of the layer (z2) of the recording medium to exhibit the effect of preventing the generation of streaks on a printed material.

In the ink-jet printing ink, the humectant can be used for the purpose of preventing drying of the ink-jet printing ink. The humectant is preferably used in an amount in the range of 3% by mass to 50% by mass relative to the total amount of the ink-jet printing ink.

The ink-jet printing ink can be produced by mixing a colorant such as the pigment or dye described above, a pigment dispersant if a pigment is used, an aqueous medium, and as needed, optional components such as a surfactant, a binder resin, a compound having a urea bond, and an organic solvent.

In the mixing, it is possible to use, for example, dispersing devices such as a bead mill, an ultrasonic homogenizer, a high-pressure homogenizer, a paint shaker, a ball mill, a roll mill, a sand mill, a sand grinder, a DYNO-MILL, a DISPERMAT, an SC-MILL, and a NANOMIZER.

More specifically, the method for producing the ink-jet printing ink may be a method including mixing a colorant, a pigment dispersant if a pigment is used, an aqueous medium, and as needed, optional components such as a surfactant, a binder resin, a compound having a urea bond, and an organic solvent at a time, and performing stirring or the like.

Another method for producing the ink-jet printing ink may be a method including, for example,

<1> a step of mixing a pigment dispersant such as the polymer (G), a colorant such as the pigment, and as needed, a solvent and the like to produce a colorant dispersion a containing the colorant at a high concentration, <2> a step of mixing the compound having a urea bond and, as needed, a solvent to produce a composition b, <3> a step of producing a composition c containing the binder resin, the aqueous medium, and the like, and <4> a step of mixing the colorant dispersion a, the composition b, and the composition c.

The ink-jet printing ink obtained by any of the methods described above is preferably subjected to a centrifugal separation process or a filtration process, as needed, in order to remove impurities contained in the ink-jet printing ink.

The pH of the ink-jet printing ink in the present invention is preferably 7.0 or more, more preferably 7.5 or more, and still more preferably 8.0 or more from the viewpoint of improving storage stability and ejection stability of the ink-jet printing ink and improving wettability, printing density, and rubfastness when the ink-jet printing ink is printed on the layer (z2) of the recording medium. The upper limit of the pH of the ink-jet printing ink is preferably 11.0 or less, more preferably 10.5 or less, and still more preferably 10.0 or less from the viewpoint of suppressing degradation of members (for example, ink ejection ports and ink flow passages) that constitute a device for applying or ejecting the ink-jet printing ink and reducing the influence that occurs when the ink-jet printing ink adheres to the skin.

The ink-jet printing ink used preferably contains an acrylic polymer having a hydrolyzable silyl group or silanol group from the viewpoint of achieving the effect that a printed material produced by printing the ink on the recording medium exhibits good water resistance and rubfastness.

The ink-jet printing ink used preferably contains the acrylic polymer having a hydrolyzable silyl group or silanol group in an amount of 1% by mass to 7% by mass, and more preferably in the range of 2% by mass to 6% by mass relative to the total amount of the ink-jet printing ink from the viewpoint of achieving the effect that a printed material produced by printing the ink on the recording medium exhibits good water resistance and rubfastness.

A method for producing a printed material by performing printing on the recording medium by using the ink-jet printing ink described above may be a method including applying the ink-jet printing ink to the recording medium by an ink-jet recording process in which a distance from an ink-jet head surface (x) having ink ejection ports to a position (y) at which a perpendicular of the surface (x) intersects the recording medium is 1 mm or more.

A method for producing a printed material according to the present invention includes applying the primer for ink-jet printing inks to the whole or part of at least one surface of the substrate (z1) to form the layer (z2); and subsequently applying an ink-jet printing ink to the layer (z2) in a state where the aqueous medium is present by an ink-jet recording process in which a distance from an ink-jet head surface (x) having ink ejection ports to a position (y) at which a perpendicular of the surface (x) intersects a surface of the layer (z2) of the recording medium is 1 mm or more.

A method for producing a printed material according to the present invention includes, within 60 seconds from completion of application of the primer for ink-jet printing inks to the whole or part of at least one surface of the substrate (z1), applying an ink-jet printing ink to a surface of the layer (z2) included in the recording medium by an ink-jet recording process in which a distance from an ink-jet head surface (x) having ink ejection ports to a position (y) at which a perpendicular of the surface (x) intersects the surface of the layer (z2) of the recording medium is 1 mm or more.

In the methods for producing a printed material, matters described for the printing system according to the present invention can be applied.

The printed material obtained by any of the methods has a pigment or a dye contained in the ink-jet printing ink on a surface of the layer (z2) or in the layer (z2) included in the recording medium.

Examples of the printed material include various printed materials such as packaging materials produced by performing printing on corrugated cardboard or the like, calendars, advertisements, and catalogues.

### EXAMPLES

The present invention will be described in more detail below with reference to Examples.

### Example 1

5.2 parts by mass of a composition A containing a styrene-acrylic copolymer A (glass transition temperature: 92° C., acid value: 46) and water, 28.6 parts by mass of propylene glycol (manufactured by AGC Inc.), 16.0 parts by mass of purified glycerin (manufactured by Kao Corporation), 0.2 parts by mass of triethanolamine (manufactured by Mitsui Chemicals, Inc.), 0.1 parts by mass of ACTICIDE B-20 (manufactured by Thor GmbH), 5.6 parts by mass of ethylene urea (manufactured by BASF), 0.6 parts by mass of SURFYNOL 420 (manufactured by EVONIK), and 43.7 parts by mass of water were mixed to prepare a primer (Y1) for ink-jet printing inks, the primer (Y1) having a content of the styrene-acrylic copolymer A of 2.5% by mass relative to the total amount of the primer for ink-jet printing inks.

Next, the primer (Y1) for ink-jet printing inks was applied to the whole of one surface of corrugated cardboard serving as a substrate, the corrugated cardboard having a thickness of 2 mm and having a white color layer on the one surface thereof, by using an ink-jet printing device (OnePassJET, manufactured by Tritek Co., Ltd.). In that case, the primer (Y1) for ink-jet printing inks was applied so as to have a mass per unit area of 2 g/m. The distance (gap) from a surface (x) of an ink-jet head included in the ink-jet printing device, the surface (x) having ink ejection ports, to a position (y) at which a perpendicular of the surface (x) intersected the surface of the color layer included in the substrate was set to 3 mm.

Next, the coated surface was irradiated with nine near-infrared heaters each having a power of 1 kW for one second from a position at which an irradiation distance to the primer-coated surface was 10.5 cm to dry the primer. A recording medium having, on the whole of the one surface of the substrate, a layer formed of the primer (Y1) for ink-jet printing inks was obtained. At that time, the layer was in a state of not being completely dried and still having tackiness.

Next, a 100% solid image was printed on the surface of the layer in the state of not being completely dried and still having tackiness by using an ink-jet printing ink described later with the OnePassJET manufactured by Tritek Co., Ltd. to obtain a printed material. In that case, the distance (gap) from the surface (x) of the ink-jet head included in the ink-jet printing device, the surface (x) having ink ejection ports, to a position (y) at which a perpendicular of the surface (x) intersected the surface of the primer layer of the recording medium was set to 3 mm.

### Example 2

A primer (Y2) for ink-jet printing inks, a recording medium, and a printed material were obtained by the same method as that in Example 1 except that a composition B containing a styrene-acrylic copolymer B (glass transition temperature: 80° C., acid value: 60) and water was used instead of the composition A in such an amount that the content of the styrene-acrylic copolymer B was 2.5% by mass relative to the total amount of the primer for ink-jet printing inks.

### Example 3

A primer (Y3) for ink-jet printing inks, a recording medium, and a printed material were obtained by the same method as that in Example 1 except that a composition C containing a styrene-acrylic copolymer C (glass transition temperature: 96, acid value: 149) and water was used instead of the composition A in such an amount that the content of the styrene-acrylic copolymer C was 2.5% by mass relative to the total amount of the primer for ink-jet printing inks.

### Example 4

A primer (Y4) for ink-jet printing inks, a recording medium, and a printed material were obtained by the same method as that in Example 1 except that a composition D containing a vinyl chloride-acrylic polymer D (glass transition temperature: 57, acid value: 35, use ratio of vinyl chloride relative to the total amount of monomers constituting the vinyl chloride-acrylic polymer D: 50% by mass) and water was used instead of the composition A in such an amount that the content of the vinyl chloride-acrylic polymer D was 2.5% by mass relative to the total amount of the primer for ink-jet printing inks.

### Example 5

A primer (Y5) for ink-jet printing inks, a recording medium, and a printed material were obtained by the same method as that in Example 1 except that a composition E containing a vinyl chloride-acrylic polymer E (manufactured by Nissin Chemical Industry Co., Ltd., glass transition temperature: 66, acid value: 35, use ratio of vinyl chloride relative to the total amount of monomers constituting the vinyl chloride-acrylic polymer E: 70% by mass) and water was used instead of the composition A in such an amount that the content of the vinyl chloride-acrylic polymer E was 2.5% by mass relative to the total amount of the primer for ink-jet printing inks.

### Example 6

A recording medium and a printed material were obtained by the same method as that in Example 1 except that the mass per unit area of the primer (Y1) for ink-jet printing inks was changed from 2 g/m² to 1 g/m².

### Example 7

A recording medium and a printed material were obtained by the same method as that in Example 1 except that the mass per unit area of the primer (Y1) for ink-jet printing inks was changed from 2 g/m² to 3 g/m².

### Example 8

A recording medium and a printed material were obtained by the same method as that in Example 1 except that the mass per unit area of the primer (Y1) for ink-jet printing inks was changed from 2 g/m² to 4 g/m².

### Example 9

A recording medium and a printed material were obtained by the same method as that in Example 4 except that the mass per unit area of the primer (Y4) for ink-jet printing inks was changed from 2 g/m² to 1 g/m².

### Example 10

A recording medium and a printed material were obtained by the same method as that in Example 4 except that the mass per unit area of the primer (Y4) for ink-jet printing inks was changed from 2 g/m² to 3 g/m².

### Example 11

A recording medium and a printed material were obtained by the same method as that in Example 4 except that the mass per unit area of the primer (Y4) for ink-jet printing inks was changed from 2 g/m² to 4 g/m².

### Example 12

A recording medium and a printed material were obtained by the same method as that in Example 1 except that the mass per unit area of the primer (Y1) for ink-jet printing inks was changed from 2 g/m² to 4.5 g/m².

### Example 13

A recording medium and a printed material were obtained by the same method as that in Example 1 except that the mass per unit area of the primer (Y1) for ink-jet printing inks was changed from 2 g/m² to 5 g/m².

### Example 14

A recording medium and a printed material were obtained by the same method as that in Example 4 except that the mass per unit area of the primer (Y4) for ink-jet printing inks was changed from 2 g/m² to 4.5 g/m².

### Example 15

A recording medium and a printed material were obtained by the same method as that in Example 4 except that the mass per unit area of the primer (Y4) for ink-jet printing inks was changed from 2 g/m² to 5 g/m².

### Example 16

A recording medium and a printed material were obtained by the same method as that in Example 7 except that the method for drying the primer was changed from the method in which irradiation was performed by using the near-infrared heaters for one second to a method in which the substrate coated with the primer was left to stand in an environment of still air at 25° C. for 12 hours.

### Example 17

A recording medium and a printed material were obtained by the same method as that in Example 7 except that the method for drying the primer was changed from the method in which irradiation was performed by using the near-infrared heaters for one second to a method in which the substrate coated with the primer was left to stand in an environment of still air at 25° C. for 60 seconds.

### Example 18

A recording medium and a printed material were obtained by the same method as that in Example 7 except that the method for drying the primer was changed from the method in which irradiation was performed by using the near-infrared heaters for one second to a method in which the substrate coated with the primer was left to stand in an environment of still air at 25° C. for 30 seconds.

### Example 19

A recording medium and a printed material were obtained by the same method as that in Example 7 except that the method for drying the primer was changed from the method in which irradiation was performed by using the near-infrared heaters for one second to a method in which the substrate coated with the primer was left to stand in an environment of still air at 25° C. for 10 seconds.

### Example 20

A recording medium and a printed material were obtained by the same method as that in Example 7 except that the method for drying the primer was changed from the method in which irradiation was performed by using the near-infrared heaters for one second to a method in which irradiation was performed by using the near-infrared heaters for three seconds.

### Example 21

A recording medium and a printed material were obtained by the same method as that in Example 7 except that the method for drying the primer was changed from the method in which irradiation was performed by using the near-infrared heaters for one second to a method in which the substrate coated with the primer was left to stand in an environment of still air at 25° C. within one second, and immediately after the leaving in the environment, printing was performed by using an ink-jet printing ink described later.

### Example 22

A recording medium and a printed material were obtained by the same method as that in Example 1 except that the distance (gap) from the surface (x) of the ink-jet head included in the ink-jet printing device, the surface (x) having ink ejection ports, to the position (y) at which a perpendicular of the surface (x) intersected the surface of the color layer of the substrate was changed from 3 mm to 2 mm, and the distance (gap) from the surface (x) of the ink-jet head included in the ink-jet printing device, the surface (x) having ink ejection ports, to the position (y) at which a perpendicular of the surface (x) intersected the surface of the primer layer of the recording medium was changed from 3 mm to 2 mm.

### Example 23

A recording medium and a printed material were obtained by the same method as that in Example 1 except that the distance (gap) from the surface (x) of the ink-jet head included in the ink-jet printing device, the surface (x) having ink ejection ports, to the position (y) at which a perpendicular of the surface (x) intersected the surface of the color layer of the substrate was changed from 3 mm to 4 mm, and the distance (gap) from the surface (x) of the ink-jet head included in the ink-jet printing device, the surface (x) having ink ejection ports, to the position (y) at which a perpendicular of the surface (x) intersected the surface of the primer layer of the recording medium was changed from 3 mm to 4 mm.

### Example 24

A recording medium and a printed material were obtained by the same method as that in Example 4 except that the distance (gap) from the surface (x) of the ink-jet head included in the ink-jet printing device, the surface (x) having ink ejection ports, to the position (y) at which a perpendicular of the surface (x) intersected the surface of the color layer of the substrate was changed from 3 mm to 2 mm, and the distance (gap) from the surface (x) of the ink-jet head included in the ink-jet printing device, the surface (x) having ink ejection ports, to the position (y) at which a perpendicular of the surface (x) intersected the surface of the primer layer of the recording medium was changed from 3 mm to 2 mm.

### Example 25

A recording medium and a printed material were obtained by the same method as that in Example 4 except that the distance (gap) from the surface (x) of the ink-jet head included in the ink-jet printing device, the surface (x) having ink ejection ports, to the position (y) at which a perpendicular of the surface (x) intersected the surface of the color layer of the substrate was changed from 3 mm to 4 mm, and the distance (gap) from the surface (x) of the ink-jet head included in the ink-jet printing device, the surface (x) having ink ejection ports, to the position (y) at which a perpendicular of the surface (x) intersected the surface of the primer layer of the recording medium was changed from 3 mm to 4 mm.

### Comparative Example 1

A printed material was obtained by the same method as that in Example 1 except that the primer (Y1) for ink-jet printing inks was not used, and an ink-jet printing ink described later was applied directly to a surface of the substrate, the surface having the color layer thereon. In that case, the distance (gap) from the surface (x) of the ink-jet head included in the ink-jet printing device, the surface (x) having ink ejection ports, to the position (y) at which a perpendicular of the surface (x) intersected the surface of the color layer included in the substrate was set to 3 mm.

### Comparative Example 2

A primer (Y2′) for ink-jet printing inks, a recording medium, and a printed material were obtained by the same method as that in Example 1 except that a composition A′ (glass transition temperature: 33, acid value: 51) containing a styrene acrylic copolymer A′ and water was used instead of the composition A in such an amount that the content of the styrene-acrylic copolymer A′ was 2.5% by mass relative to the total amount of the primer for ink-jet printing inks.

### Comparative Example 3

A primer (Y3′) for ink-jet printing inks, a recording medium, and a printed material were obtained by the same method as that in Example 1 except that a composition B′ (glass transition temperature: 5, acid value: 125) containing a styrene acrylic copolymer B′ and water was used instead of the composition A in such an amount that the content of the styrene-acrylic copolymer B′ was 2.5% by mass relative to the total amount of the primer for ink-jet printing inks.

### Comparative Example 4

A primer (Y4′) for ink-jet printing inks, a recording medium, and a printed material were obtained by the same method as that in Example 1 except that a composition C′ (glass transition temperature: 15, acid value: 45, use ratio of vinyl chloride relative to the total amount of monomers constituting the vinyl chloride-acrylic polymer C′: 40% by mass) containing a vinyl chloride-acrylic copolymer C′ and water was used instead of the composition A in such an amount that the content of the styrene-acrylic copolymer C′ was 2.5% by mass relative to the total amount of the primer for ink-jet printing inks.

### Comparative Example 5

A primer (Y5′) for ink-jet printing inks, a recording medium, and a printed material were obtained by the same method as that in Example 1 except that a composition D′ (glass transition temperature: 30, acid value: 164) containing a water-soluble styrene-acrylic copolymer D′ and water was used instead of the composition A in such an amount that the content of the styrene-acrylic copolymer D′ was 2.5% by mass relative to the total amount of the primer for ink-jet printing inks.

### Comparative Example 6

A primer (Y6′) for ink-jet printing inks, a recording medium, and a printed material were obtained by the same method as that in Example 1 except that a composition E′ (glass transition temperature: 15, acid value: 19) containing a water-soluble acrylic polymer E′ and water was used instead of the composition A in such an amount that the content of the styrene-acrylic copolymer E′ was 2.5% by mass relative to the total amount of the primer for ink-jet printing inks.

### Comparative Example 7

A recording medium for ink-jet printing inks and a printed material were obtained by the same method as that in Comparative Example 1 except that the distance (gap) from the surface (x) of the ink-jet head included in the ink-jet printing device, the surface (x) having ink ejection ports, to the position (y) at which a perpendicular of the surface (x) intersected the surface of the color layer of the substrate was changed from 3 mm to 1 mm.

### Comparative Example 8

A recording medium for ink-jet printing inks and a printed material were obtained by the same method as that in Comparative Example 1 except that the distance (gap) from the surface (x) of the ink-jet head included in the ink-jet printing device, the surface (x) having ink ejection ports, to the position (y) at which a perpendicular of the surface (x) intersected the surface of the color layer of the substrate was changed from 3 mm to 2 mm.

### Comparative Example 9

A recording medium for ink-jet printing inks and a printed material were obtained by the same method as that in Comparative Example 2 except that the distance (gap) from the surface (x) of the ink-jet head included in the ink-jet printing device, the surface (x) having ink ejection ports, to the position (y) at which a perpendicular of the surface (x) intersected the surface of the color layer of the substrate was changed from 3 mm to 1 mm, and the distance (gap) from the surface (x) of the ink-jet head included in the ink-jet printing device, the surface (x) having ink ejection ports, to the position (y) at which a perpendicular of the surface (x) intersected the surface of the primer layer of the recording medium was changed from 3 mm to 1 mm.

### Comparative Example 10

A recording medium for ink-jet printing inks and a printed material were obtained by the same method as that in Comparative Example 2 except that the distance (gap) from the surface (x) of the ink-jet head included in the ink-jet printing device, the surface (x) having ink ejection ports, to the position (y) at which a perpendicular of the surface (x) intersected the surface of the color layer of the substrate was changed from 3 mm to 2 mm, and the distance (gap) from the surface (x) of the ink-jet head included in the ink-jet printing device, the surface (x) having ink ejection ports, to the position (y) at which a perpendicular of the surface (x) intersected the surface of the primer layer of the recording medium was changed from 3 mm to 2 mm.

### Comparative Example 11

A recording medium for ink-jet printing inks and a printed material were obtained by the same method as that in Comparative Example 4 except that the distance (gap) from the surface (x) of the ink-jet head included in the ink-jet printing device, the surface (x) having ink ejection ports, to the position (y) at which a perpendicular of the surface (x) intersected the surface of the color layer of the substrate was changed from 3 mm to 1 mm, and the distance (gap) from the surface (x) of the ink-jet head included in the ink-jet printing device, the surface (x) having ink ejection ports, to the position (y) at which a perpendicular of the surface (x) intersected the surface of the primer layer of the recording medium was changed from 3 mm to 1 mm.

### Comparative Example 12

A recording medium for ink-jet printing inks and a printed material were obtained by the same method as that in Comparative Example 4 except that the distance (gap) from the surface (x) of the ink-jet head included in the ink-jet printing device, the surface (x) having ink ejection ports, to the position (y) at which a perpendicular of the surface (x) intersected the surface of the color layer of the substrate was changed from 3 mm to 2 mm, and the distance (gap) from the surface (x) of the ink-jet head included in the ink-jet printing device, the surface (x) having ink ejection ports, to the position (y) at which a perpendicular of the surface (x) intersected the surface of the primer layer of the recording medium was changed from 3 mm to 2 mm.

(Glass Transition Temperature)

The glass transition temperature (K) of a vinyl polymer is a theoretically calculated value determined by the following FOX equation using glass transition temperatures of homopolymers of monomers constituting the vinyl polymer.

1/Tg=W1/Tg1+W2/Tg2+ . . . +Wn/Tgn

(In the equation, Tg is a glass transition temperature (K) of a vinyl polymer, W1, W2, . . . , and Wn are weight fractions of respective monomers, and Tg1, Tg2, . . . , and Tgn are glass transition temperatures of homopolymers of respective monomers.)

The glass transition temperatures of homopolymers used in the above calculation are values included in “POLYMER HANDBOOK THIRD EDITION” (A WILEY-INTERSCIENCE PUBLICATION).

(Acid Value)

The acid value is the number of milligrams of potassium hydroxide theoretically required to neutralize 1 g of non-volatile components of the vinyl polymer and is a theoretical acid value that is arithmetically determined on the basis of the amount of a monomer having an acid group, the monomer being used in the production of the vinyl polymer, from the mass of potassium hydroxide required to neutralize all the acid groups.

The presence or absence of streak-like patterns and the like of the printed materials obtained by the above methods was evaluated by the following method. The presence or absence of white streak-like patterns and pinholes of the printed materials obtained in Examples and Comparative Examples was evaluated by visual observation in accordance with the following criteria.

AAA: Neither white streak-like patterns nor pinholes were observed.

AA: White streak-like patterns having a length of less than 1 cm were observed at less than three points, and no pinholes were observed.

A: White streak-like patterns having a length of less than 1 cm were observed at three points or more and less than ten points, and no pinholes were observed.

B: No white streak-like patterns were observed, but pinholes were observed.

C: White streak-like patterns having a length of 1 cm or more and less than 5 cm were observed at three points or more and less than ten points, and no pinholes were observed.

D: White streak-like patterns having a length of 5 cm or more and 10 cm were observed at 10 points or more and less than 20 points, and no pinholes were observed.

E: White streak-like patterns having a length of 5 cm or more and 10 cm were observed at 20 points or more, and no pinholes were observed.

TABLE 1

| | Example 1 | Example 2 | Example 3 | Example 4 | Example 5 |
|---|---|---|---|---|---|
| Vinyl polymer | Styrene- | Styrene- | Styrene- | Vinyl | Vinyl |
| | acrylic | acrylic | acrylic | chloride- | chloride- |
| | copolymer A | copolymer B | copolymer C | acrylic | acrylic |
| | | | | polymer D | polymer E |
| Glass transition | 92 | 80 | 96 | 57 | 66 |
| temperature (° C.) | | | | | |
| Acid value | 46 | 60 | 149 | 35 | 35 |
| Mass per unit area | 2 | 2 | 2 | 2 | 2 |
| of primer for ink-jet | | | | | |
| printing inks (g/m²) | | | | | |
| Gap (mm) | 3 | 3 | 3 | 3 | 3 |
| Drying method | Near- | Near- | Near- | Near- | Near- |
| | infrared | infrared | infrared | infrared | infrared |
| Drying time | 1 second | 1 second | 1 second | 1 second | 1 second |
| Presence or absence | AA | A | A | AA | AA |
| of streaks and the like | | | | | |

TABLE 2

| | Comparative | Comparative | Comparative | Comparative | Comparative | Comparative |
|---|---|---|---|---|---|---|
| | Example 1 | Example 2 | Example 3 | Example 4 | Example 5 | Example 6 |
| Vinyl polymer | — | Styrene- | Styrene- | Vinyl | Water- | Water- |
| | | acrylic | acrylic | chloride- | soluble | soluble |
| | | copolymer A′ | copolymer B′ | acrylic | styrene- | acrylic |
| | | | | polymer C′ | acrylic | polymer E′ |
| | | | | | copolymer D′ | |
| Glass transition | — | 33 | 5 | 15 | 30 | 15 |
| temperature (° C.) | | | | | | |
| Acid value | — | 51 | 125 | 45 | 164 | 19 |
| Mass per unit | — | 2 | 2 | 2 | 2 | 2 |
| area of primer for | | | | | | |
| ink-jet printing | | | | | | |
| inks (g/m²) | | | | | | |
| Gap (mm) | 3 | 3 | 3 | 3 | 3 | 3 |
| Drying method | — | Near- | Near- | Near- | Near- | Near- |
| | | infrared | infrared | infrared | infrared | infrared |
| Drying time | | 1 second | 1 second | 1 second | 1 second | 1 second |
| Presence or | D | D | E | E | E | E |
| absence of | | | | | | |
| streaks and | | | | | | |
| the like | | | | | | |

TABLE 3

| | Example 6 | Example 7 | Example 8 | Example 9 |
|---|---|---|---|---|
| Vinyl polymer | Styrene- | Styrene- | Styrene- | Vinyl |
| | acrylic | acrylic | acrylic | chloride- |
| | copolymer A | copolymer A | copolymer A | acrylic |
| | | | | polymer D |
| Glass transition | 92 | 92 | 92 | 57 |
| temperature (° C.) | | | | |
| Acid value | 46 | 46 | 46 | 35 |
| Mass per unit area | 1 | 3 | 4 | 1 |
| of primer for ink-jet | | | | |
| printing inks (g/m²) | | | | |
| Gap (mm) | 3 | 3 | 3 | 3 |
| Drying method | Near- | Near- | Near- | Near- |
| | infrared | infrared | infrared | infrared |
| Drying time | 1 second | 1 second | 1 second | 1 second |
| Presence or absence | A | AA | AA | A |
| of streaks and the like | | | | |

TABLE 4

| | Example 10 | Example 11 | Example 12 | Example 13 | Example 14 | Example 15 |
|---|---|---|---|---|---|---|
| Vinyl polymer | Vinyl | Vinyl | Serene- | Styrene- | Vinyl | Vinyl |
| | chloride- | chloride- | acrylic | acrylic | chloride- | chloride- |
| | acrylic | acrylic | copolymer | copolymer | acrylic | acrylic |
| | polymer D | polymer D | A | A | polymer D | polymer D |
| Glass transition | 57 | 57 | 92 | 92 | 57 | 57 |
| temperature (° C.) | | | | | | |
| Acid value | 35 | 35 | 46 | 46 | 35 | 35 |
| Mass per unit | 3 | 4 | 4.5 | 5 | 4.5 | 5 |
| area of primer for | | | | | | |
| ink-jet printing | | | | | | |
| inks (g/m²) | | | | | | |
| Gap (mm) | 3 | 3 | 3 | 3 | 3 | 3 |
| Drying method | Near- | Near- | Near- | Near- | Near- | Near- |
| | infrared | infrared | infrared | infrared | infrared | infrared |
| Drying time | 1 second | 1 second | 1 second | 1 second | 1 second | 1 second |
| Presence or | AA | AA | B | B | B | B |
| absence of | | | | | | |
| streaks and | | | | | | |
| the like | | | | | | |

TABLE 5

| | Example 16 | Example 17 | Example 18 | Example 19 | Example 20 | Example 21 |
|---|---|---|---|---|---|---|
| Vinyl polymer | Styrene- | Styrene- | Styrene- | Styrene- | Styrene- | Styrene- |
| | acrylic | acrylic | acrylic | acrylic | acrylic | acrylic |
| | copolymer A | copolymer A | copolymer A | copolymer A | copolymer A | copolymer A |
| Glass transition | 92 | 92 | 92 | 92 | 92 | 92 |
| temperature (° C.) | | | | | | |
| Acid value | 46 | 46 | 46 | 46 | 46 | 46 |
| Mass per unit | 3 | 3 | 3 | 3 | 3 | 3 |
| area of primer for | | | | | | |
| ink-jet printing | | | | | | |
| inks (g/m²) | | | | | | |
| Gap (mm) | 3 | 3 | 3 | 3 | 3 | 3 |
| Drying method | Still air | Still air | Still air | Still air | Near- | Still air |
| | at 25° C. | at 25° C. | at 25° C. | at 25° C. | infrared | at 25° C. |
| Drying time | for 12 | for 60 | for 30 | for 10 | for 3 | within 1 |
| | hours | seconds | seconds | seconds | seconds | second |
| Presence or | A | A | A | A | AA | A |
| absence of | | | | | | |
| streaks and | | | | | | |
| the like | | | | | | |

TABLE 6

| | | | | | Comparative | Comparative |
|---|---|---|---|---|---|---|
| | Example 22 | Example 23 | Example 24 | Example 25 | Example 7 | Example 8 |
| Vinyl polymer | Styrene- | Styrene- | Vinyl | Vinyl | — | — |
| | acrylic | acrylic | chloride- | chloride- | | |
| | copolymer A | copolymer A | acrylic | acrylic | | |
| | | | polymer D | polymer D | | |
| Glass transition | 92 | 92 | 57 | 57 | — | — |
| temperature (° C.) | | | | | | |
| Acid value | 46 | 46 | 35 | 35 | — | — |
| Mass per unit | 2 | 2 | 2 | 2 | — | — |
| area of primer for | | | | | | |
| ink-jet printing | | | | | | |
| inks (g/m²) | | | | | | |
| Gap (mm) | 2 | 4 | 2 | 4 | 1 | 2 |
| Drying method | — | Near- | Near- | Near- | Near- | Near- |
| | | infrared | infrared | infrared | infrared | infrared |
| Drying time | | 1 second | 1 second | 1 second | 1 second | 1 second |
| Presence or | AAA | A | AAA | A | C | C |
| absence of | | | | | | |
| streaks and | | | | | | |
| the like | | | | | | |

TABLE 7

| | Comparative | Comparative | Comparative | Comparative |
|---|---|---|---|---|
| | Example 9 | Example 10 | Example 11 | Example 12 |
| Vinyl polymer | Styrene- | Styrene- | Vinyl | Vinyl |
| | acrylic | acrylic | chloride- | chloride- |
| | copolymer A′ | copolymer A′ | acrylic | acrylic |
| | | | polymer C′ | polymer C′ |
| Glass transition | 33 | 33 | 15 | 15 |
| temperature (° C.) | | | | |
| Acid value | 51 | 51 | 45 | 45 |
| Mass per unit area | 2 | 2 | 2 | 2 |
| of primer for ink-jet | | | | |
| printing inks (g/m²) | | | | |
| Gap (mm) | 1 | 2 | 1 | 2 |
| Drying method | Near- | Near- | Near- | Near- |
| | infrared | infrared | infrared | infrared |
| Drying time | 1 second | 1 second | 1 second | 1 second |
| Presence or absence | D | D | D | D |
| of streaks and the like | | | | |

In the production of the printed materials, an ink-jet printing ink prepared as described below was used.

(Production Example: Aqueous pigment dispersion) An intensive mixer (manufactured by Nippon Eirich Co., Ltd.) was charged with 100 parts by mass of carbon black 4960 (manufactured by Mitsubishi Chemical Corporation) serving as a pigment and 40 parts by mass of a styrene-acrylic acid resin Hi-Ros-X DX-100 (manufactured by Seiko PMC Corporation), and mixing was performed at a rotor peripheral speed of 2.9 m/s and a pan peripheral speed of 1 m/s. Next, 50 parts by mass of propylene glycol and 13 parts by mass of a 34 mass % aqueous potassium hydroxide solution were added to the mixture and kneaded for two hours.

Next, 464 parts by mass of ion-exchange water serving as a dispersion medium was gradually added to the kneaded product in the intensive mixer under continuous stirring. An aqueous pigment dispersion (R1) having a pigment concentration of 15% by mass was thereby obtained.

(Production Example: Binder Resin)

A four-necked flask equipped with a stirrer, a thermometer, a reflux condenser, and a nitrogen inlet tube was charged with 16 parts by mass of “Newcol 707SF” [an anionic emulsifier manufactured by Nippon Nyukazai Co., Ltd.], 6.5 parts by mass of “NOIGEN TDS-200D” [a nonionic emulsifier manufactured by DKS Co. Ltd.], and 220 parts by mass of deionized water. The temperature of the resulting mixture was increased to 80° C. in a nitrogen stream, and an aqueous solution prepared by dissolving 0.8 parts by mass of ammonium persulfate in 16 parts by mass of deionized water was then added. Furthermore, a liquid mixture of 60 parts by mass of 2-ethylhexyl acrylate, 100 parts by mass of styrene, 27 parts by mass of methyl methacrylate, 0.4 parts by mass of 3-methacryloxypropyltrimethoxysilane, 3 parts by mass of acrylamide, and 6 parts by mass of methacrylic acid was added dropwise over a period of three hours. After completion of the dropwise addition, the resulting mixture was caused to react for two hours, then cooled to 25° C., and neutralized with 1.5 parts by mass of 28 mass % aqueous ammonia. Deionized water was added to adjust the amount of non-volatile components to 45% by mass. An aqueous acrylic resin dispersion (R2) having a glass transition temperature (Tg) of 30° C. and a volume-average particle size of 60 nm was obtained.

### Production Example: Ink

An ink-jet printing ink was prepared by mixing 37 parts by mass of the aqueous pigment dispersion (R1), 6.3 parts by mass of the aqueous acrylic resin dispersion (R2), 10.6 parts by mass propylene glycol (manufactured by AGC Inc.), 16.0 parts by mass of purified glycerin (manufactured by Kao Corporation), 0.2 parts by mass of triethanolamine (manufactured by Mitsui Chemicals, Inc.), 0.1 parts by mass of ACTICIDE B-20 (manufactured by Thor GmbH), 5.6 parts by mass of ethylene urea (manufactured by BASF), 1.0 part by mass of SURFYNOL 420 (manufactured by EVONIK), and 22.9 parts by mass of water.

1. A primer for ink-jet printing inks, the primer comprising an aqueous medium and at least one vinyl polymer (A) selected from the group consisting of a vinyl polymer (A1) having a structural unit derived from an aromatic vinyl monomer and having a glass transition temperature of 50° C. to 100° C. and a halogenated vinyl polymer (A2) having a glass transition temperature of 50° C. to 100° C.

2. The primer for ink-jet printing inks according to claim 1, wherein the vinyl polymer (A1) has a structural unit derived from an aromatic vinyl monomer and a structural unit derived from a (meth)acrylic monomer other than the aromatic vinyl monomer.

3. The primer for ink-jet printing inks according to claim 2, wherein the vinyl polymer (A1) has the structural unit derived from the aromatic vinyl monomer in an amount of 50% by mass to 99% by mass relative to a total amount of the vinyl polymer (A).

4. The primer for ink-jet printing inks according to claim 1, wherein the halogenated vinyl polymer (A1) has a structural unit derived from a vinyl chloride monomer and a structural unit derived from a (meth)acrylic monomer other than the vinyl chloride monomer.

5. The primer for ink-jet printing inks according to claim 4, wherein the vinyl polymer (A2) has the structural unit derived from the vinyl chloride monomer in an amount of 30% by mass to 90% by mass relative to a total amount of the vinyl polymer (A2).

6. The primer for ink-jet printing inks according to claim 1, wherein the vinyl polymer (A) has an acid value of 100 or less.

7. A recording medium comprising a substrate (z1) and a layer (z2) disposed on the whole or part of at least one surface of the substrate (z1) and formed from the primer for ink-jet printing inks according to claim 1.

8. The recording medium according to claim 7, wherein the primer for ink-jet printing inks has a mass per unit area in a range of 1 g/m² to 4 g/m².

9. The recording medium according to claim 8, wherein the recording medium is subjected to printing by an ink-jet recording process in which a distance from an ink-jet head surface (x) having ink ejection ports to a position (y) at which a perpendicular of the surface (x) intersects a surface of the layer (z2) of the recording medium is 1 mm or more.

10. The recording medium according to claim 7, wherein the substrate (z1) has an amount of water absorption of 10 g/m² or less when a surface of the substrate (z1) is brought into contact with water for 100 msec.

11. The recording medium according to claim 7, wherein the substrate (z1) is corrugated cardboard.

12. A method for producing a recording medium, comprising applying the primer for ink-jet printing inks according to claim 1 to the whole or part of at least one surface of a substrate (z1) and drying the primer as needed to form a layer (z2).

13. The method for producing a recording medium according to claim 12, wherein the step of applying the primer for ink-jet printing inks is a step of applying g primer for ink-jet printing inks by a jet recording process,
wherein the primer for ink-jet printing inks comprises an aqueous medium and at least one vinyl polymer (A) selected from the group consisting of a vinyl polymer (A1) having a structural unit derived from an aromatic vinyl monomer and having a glass transition temperature of 50° C. to 100° C. and a halogenated vinyl polymer (A2) having a glass transition temperature of 50° C. to 100° C.

14. A printing system comprising applying an ink-jet printing ink to the recording medium according to claim 7 by an ink-jet recording process in which a distance from an ink-jet head surface (x) having ink ejection ports to a position (y) at which a perpendicular of the surface (x) intersects a surface of the layer (z2) of the recording medium is 1 mm or more.

15. The printing system according to claim 14, wherein the ink-jet printing ink has a viscosity in a range of 2 mPa·s or more and less than 12 mPa·s and has a surface tension of 20 mN/m to 40 mN/m.

16. The printing system according to claim 14, wherein the ink-jet printing ink contains an acrylic polymer having a hydrolyzable silyl ether group in an amount of 1% by mass to 7% by mass relative to a total amount of the ink-jet printing ink.

17. A printed material comprising a pigment or a dye contained in an ink-jet printing ink on a surface of the layer (z2) or in the layer (z2) included in the recording medium according to claim 7.

18. A method for producing a printed material, comprising applying an ink-jet printing ink to the recording medium according to claim 7 by an ink-jet recording process in which a distance from an ink-jet head surface (x) having ink ejection ports to a position (y) at which a perpendicular of the surface (x) intersects a surface of the layer (z2) of the recording medium is 1 mm or more.

19. A method for producing a printed material, comprising applying the primer for ink-jet printing inks according to claim 1 to the whole or part of at least one surface of a substrate (z1) to form the layer (z2); and subsequently applying an ink-jet printing ink to the layer (z2) in a state where the aqueous medium is present by an ink-jet recording process in which a distance from an ink-jet head surface (x) having ink ejection ports to a position (y) at which a perpendicular of the surface (x) intersects a surface of the layer (z2) of the recording medium is 1 mm or more.

20. A method for producing a printed material, comprising, within 60 seconds from completion of application of the primer for ink-jet printing inks according to claim 1 to the whole or part of at least one surface of a substrate (z1), applying an ink-jet printing ink to a surface of the layer (z2) included in the recording medium by an ink-jet recording process in which a distance from an ink-jet head surface (x) having ink ejection ports to a position (y) at which a perpendicular of the surface (x) intersects the surface of the layer (z2) of the recording medium is 1 mm or more.
